(19) United States
(12) Patent Application Publication
(10) Pub. No.: US 2026/0264472 A1
(43) Pub. Date: Sep. 10, 2026

(54) VEHICLE AIR CONDITIONING SYSTEM AND AIR CONDITIONING CONTROL DEVICE

(71) Applicant: DENSO CORPORATION, Kariya-city (JP)

(72) Inventors: Koji OTA, Kariya-city (JP); Takuya Kataoka, Kariya-city (JP); Kohei Tomita, Kariya-city (JP); Fuminobu Mikami, Kariya-city (JP); Shigeru Kawano, Kariya-city (JP)

(21) Appl. No.: 19/660,083

(22) Filed: Apr. 27, 2026

Related U.S. Application Data
(63) Continuation of application No. PCT/JP2024/036970, filed on Oct. 17, 2024.

(30) Foreign Application Priority Data
Oct. 31, 2023 (JP) 2023-186984

(51) Int. Cl. B60H 1/00; H05B 3/84

(52) U.S. Cl. CPC B60H 1/00785; B60H 1/00742; B60H 1/00792; B60H 1/008; B60H 1/00849; H05B 3/84; H05B 2203/037

(57) ABSTRACT

A windshield heater is provided on a windshield of a vehicle and is capable of heating the windshield. An air conditioner includes a blower unit capable of adjusting a ratio of an amount of outside air introducing into a vehicle cabin and an amount of inside air circulating in the vehicle cabin, and an air conditioning unit configured to heat air supplied from the blower unit with an air conditioning heater. An air conditioning ECU drives the windshield heater for defogging, drives the air conditioning heater to control an inside air temperature of the vehicle cabin to a set temperature, and drives the blower unit to lower a ratio of an amount of outside air introducing into the vehicle cabin and to increase a ratio of an amount of inside air circulating in the vehicle cabin.

### CROSS REFERENCE TO RELATED APPLICATION

The present application is a continuation application of International Patent Application No. PCT/JP2024/036970 filed on Oct. 17, 2024, which designated the U.S. and claims the benefit of priority from Japanese Patent Application No. 2023-186984 filed on Oct. 31, 2023. The entire disclosures of all of the above applications are incorporated herein by reference.

### TECHNICAL FIELD

The present disclosure relates to a vehicle air conditioning system and an air conditioning control device.

### BACKGROUND

Conventionally, vehicles such as electric vehicles, fuel cell vehicles, hybrid vehicles, and plug-in hybrid vehicles are known, in which a windshield heater is provided to generate heat for a windshield when energized.

### SUMMARY

According to one aspect of the present disclosure, a vehicle air conditioning system may be provided with: a windshield heater provided on a windshield of a vehicle to heat the windshield; an air conditioner including (i) a blower unit capable of adjusting a ratio of an amount of outside air introducing into a vehicle cabin and an amount of inside air circulating in the vehicle cabin, and (ii) an air conditioning unit configured to heat the air supplied from the blower unit with an air conditioning heater and to blow the air into the vehicle cabin; an outside air temperature sensor configured to detect an outside air temperature as a temperature outside the vehicle cabin; an inside air temperature sensor configured to detect an inside air temperature in the vehicle cabin; and an air conditioning control device that is configured to perform a control in which the windshield heater is driven to prevent the windshield from fogging up, the air conditioning heater is driven to control the inside air temperature of the vehicle cabin to a set temperature, and the blower unit is driven (i) to lower the ratio of the amount of the outside air introducing into the vehicle cabin and (ii) to increase the ratio of the amount of inside air circulating in the vehicle cabin in accordance to the outside air temperature.

According to another aspect of the present disclosure, an air conditioning control device may be configured to control a windshield heater provided on a windshield of the vehicle and to control operation of an air conditioner. The vehicle is provided with: the windshield heater configured to heat the windshield; the air conditioner including a blower unit capable of adjusting a ratio of an amount of outside air introducing into a vehicle cabin and an amount of inside air circulating in the vehicle cabin, and an air conditioning unit configured to heat air supplied from the blower unit with an air conditioning heater and to blow the air into the vehicle cabin; an outside air temperature sensor configured to detect an outside air temperature as a temperature outside the vehicle cabin; and an inside air temperature sensor configured to detect an inside air temperature in the vehicle cabin. In this case, the air conditioning control device may be configured to perform a control in which the windshield heater is driven to prevent the windshield from fogging up, the air conditioning heater is driven to maintain the inside air temperature of the vehicle carbine at a set temperature, and the blower unit is driven to (i) lower a ratio of an amount of the outside air introducing into the vehicle cabin and (ii) increase a ratio of inside air circulating in the vehicle cabin in accordance with the outside air temperature.

According to a further another aspect of the present disclosure, a vehicle air conditioning system may be provided with: a windshield heater provided on a windshield of a vehicle to heat the windshield; an air conditioner including a blower unit configured to drawn in outside air outside of the vehicle cabin and inside air inside of the vehicle cabin and an air conditioning unit configured to heat air supplied by the blower unit with an air conditioning heater and to blow the air into the vehicle cabin; and an air conditioning control device configured to perform a control in which the windshield heater is driven in each of a deicing mode in which the windshield is deiced, a demisting mode in which the windshield is demisted, a defogging mode in which the windshield is prevented from fogging, and a human body temperature adjusting mode in which an occupant is warmed using radiant heat from the windshield heater and conditioned air is blown out from the air conditioner.

### BRIEF DESCRIPTION OF THE DRAWINGS

Objects, features, and advantages of the present disclosure will become more apparent from the following detailed description made with reference to the accompanying drawings, in which:

FIG. 1 is a schematic diagram of a vehicle air conditioning system according to a first embodiment;

FIG. 2 is a block diagram of a control system of the vehicle air conditioning system according to the first embodiment;

FIG. 3 is a graph of results of a simulation of the relationship between the total consumption of electric power of the water heater and the air conditioner and the inside air ratio for each outside air temperature;

FIG. 4 is a flowchart showing a control process performed by an air conditioning ECU provided in the vehicle air conditioning system according to the first embodiment;

FIG. 5 is a cross-sectional view showing a blower unit of an air conditioner provided in a vehicle air conditioning system according to a second embodiment;

FIG. 6 is a view corresponding to the view seen in the direction of an arrow VI in FIG. 5, and is a front view of a blower unit of an air conditioner provided in a vehicle air conditioning system according to a third embodiment;

FIG. 7 is a flowchart of a control process performed by an air conditioning ECU provided in a vehicle air conditioning system according to a fourth embodiment;

FIG. 8 is a schematic diagram of an example of an air conditioner included in a vehicle air conditioning system according to the fourth embodiment;

FIG. 9 is a schematic view of a vehicle equipped with a vehicle air conditioning system according to a fifth embodiment;

FIG. 10 is a block diagram of a control system of the vehicle air conditioning system according to the fifth embodiment;

FIG. 11 is a flowchart of the control process performed by an air conditioning ECU provided in a vehicle air conditioning system according to the fifth embodiment;

FIG. 12 is a plan view of a WS heater provided in a vehicle air conditioning system according to a sixth embodiment;

FIG. 13 is a schematic diagram of a vehicle equipped with a vehicle air conditioning system according to a seventh embodiment;

FIG. 14 is a block diagram of a control system of a vehicle air conditioning system according to the seventh embodiment;

FIG. 15 is a plan view of a WS heater provided in a vehicle air conditioning system according to an eighth embodiment;

FIG. 16 is a flowchart of a control process performed by an air conditioning ECU provided in a vehicle air conditioning system according to a ninth embodiment;

FIG. 17 is a block diagram of a control system of a vehicle air conditioning system according to a tenth embodiment;

FIG. 18 is a flowchart of a control process performed by an air conditioning ECU provided in a vehicle air conditioning system according to an eleventh embodiment;

FIG. 19 is a flowchart of a control process performed by an air conditioning ECU provided in a vehicle air conditioning system according to a twelfth embodiment; and

FIG. 20 is a flowchart showing a control process performed by an air conditioning ECU provided in a vehicle air conditioning system according to a thirteenth embodiment.

### DESCRIPTION OF EMBODIMENTS

Vehicles such as electric vehicles, fuel cell vehicles, hybrid vehicles, and plug-in hybrid vehicles are known, in which a windshield heater is provided to generate heat for a windshield when energized. Hereinafter, the windshield is abbreviated to “WS” and the windshield heater is referred to as “WS heater.” For example, an air conditioning system may perform a control for heating a WS using a WS heater without driving an air conditioner in a defroster mode, in conditions where fogging on the WS is met, such as in a condition where an outside air temperature drops below a predetermined temperature threshold value. However, in this case, it is important to further reduce a total energy consumed by the air conditioning heater and the WS heater.

As a result of extensive research, the inventors of the present disclosure have discovered a control method that can further reduce the total energy consumed by the air conditioning heater and the WS heater according to various conditions under which the vehicle is used.

It is an object of the present disclosure to provide a vehicle air conditioning system and an air conditioning control device that are capable of achieving both (i) reduction of the total energy consumed by an air conditioning heater and a windshield (WS) heater and (ii) defogging of a WS.

According to one aspect of the present disclosure, a vehicle air conditioning system may be provided with: a windshield heater provided on a windshield of a vehicle to heat the windshield; an air conditioner including (i) a blower unit capable of adjusting a ratio of an amount of outside air introducing into a vehicle cabin and an amount of inside air circulating in the vehicle cabin, and (ii) an air conditioning unit configured to heat the air supplied from the blower unit with an air conditioning heater and to blow the air into the vehicle cabin; an outside air temperature sensor configured to detect an outside air temperature as a temperature outside the vehicle cabin; an inside air temperature sensor configured to detect an inside air temperature in the vehicle cabin; and an air conditioning control device that is configured to perform a control in which the windshield heater is driven to prevent the windshield from fogging up, the air conditioning heater is driven to control the inside air temperature of the vehicle cabin to a set temperature, and the blower unit is driven (i) to lower the ratio of the amount of the outside air introducing into the vehicle cabin and (ii) to increase the ratio of the amount of inside air circulating in the vehicle cabin in accordance to the outside air temperature.

In the following description, the air outside the vehicle cabin may be referred to as “outside air,” and the air in the vehicle cabin is referred to as “inside air.” Further, a ratio of (i) the amount of inside air circulation relative to (ii) the total amount of introduced outside air and inside air circulation may be referred to as the “inside air ratio.” The air conditioning control device may be called as an “air conditioning ECU.” ECU is an abbreviation of electronic control unit.

According to the configuration of one aspect of the present disclosure, the air conditioning ECU increases the inside air ratio when the outside air temperature is low. In such manner, it is possible to significantly reduce an energy that is required to heat the low-temperature outside air with the air conditioning heater when the outside air temperature is low. On the other hand, as the inside air ratio increases, a relative humidity in the vehicle cabin increases, thereby the energy that is required to heat the WS by the WS heater also increases. However, when the outside air temperature is low, the increase in the energy that is required by the WS heater due to an increase in the inside air ratio is smaller than the increase in the energy that is required to heat the low-temperature outside air using the air conditioning heater, thereby reducing the total energy consumed by the air conditioning heater and the WS heater. On the other hand, when the outside air temperature is high, the air conditioning ECU lowers the inside air ratio, that is, increases the amount of introduction of outside air. In such manner, it is possible to lower the relative humidity of the inside air in the vehicle cabin and reduce the energy that is required to heat the WS by the WS heater. On the other hand, as the amount of introduction of outside air increases, the energy that is required to heat the outside air by the air conditioning heater increases. However, when the outside air temperature is high, the reduction of energy consumed by the WS heater due to the decrease in the inside air ratio is greater than the increase of energy consumed by the air conditioning heater due to the decrease in the inside air ratio, thereby the total energy consumed by the air conditioning heater and the WS heater is reduced. Therefore, when the outside air temperature is low, the vehicle air conditioning system is, by increasing the inside air ratio, capable of bringing the total energy consumed by the air conditioning heater and the WS heater closer to a minimum value according to the outside air temperature.

According to another aspect of the present disclosure, an air conditioning ECU may be configured to control a windshield heater provided on a windshield of the vehicle and to control operation of an air conditioner. The vehicle is provided with: the windshield heater configured to heat the windshield; the air conditioner including a blower unit capable of adjusting a ratio of an amount of outside air introducing into a vehicle cabin and an amount of inside air circulating in the vehicle cabin, and an air conditioning unit configured to heat air supplied from the blower unit with an air conditioning heater and to blow the air into the vehicle cabin; an outside air temperature sensor configured to detect an outside air temperature as a temperature outside the vehicle cabin; and an inside air temperature sensor configured to detect an inside air temperature in the vehicle cabin. In this case, the air conditioning ECU may be configured to perform a control in which the windshield heater is driven to prevent the windshield from fogging up, the air conditioning heater is driven to maintain the inside air temperature of the vehicle carbine at a set temperature, and the blower unit is driven to (i) lower a ratio of an amount of the outside air introducing into the vehicle cabin and (ii) increase a ratio of inside air circulating in the vehicle cabin in accordance with the outside air temperature.

In such manner, the air conditioning ECU according to another aspect of the present disclosure also achieves the same effects as the vehicle air conditioning system according to one aspect of the present disclosure.

According to a further another aspect of the present disclosure, a vehicle air conditioning system may be provided with: a windshield heater provided on a windshield of a vehicle to heat the windshield; an air conditioner including a blower unit configured to drawn in outside air outside of the vehicle cabin and inside air inside of the vehicle cabin and an air conditioning unit configured to heat air supplied by the blower unit with an air conditioning heater and to blow the air into the vehicle cabin; and an air conditioning control device configured to perform a control in which the windshield heater is driven in each of a deicing mode in which the windshield is deiced, a demisting mode in which the windshield is demisted, a defogging mode in which the windshield is prevented from fogging, and a human body temperature adjusting mode in which an occupant is warmed using radiant heat from the windshield heater and conditioned air is blown out from the air conditioner.

According to the above, when the windshield heater is driven, the radiant heat of the windshield heater can warm an upper body of the occupant. Therefore, by using the windshield heater not only for deicing, demisting, and defogging the windshield but also for adjusting the temperature of the occupants, the comfort of the air conditioning in the vehicle cabin is improvable while reducing the total energy consumed by the air conditioning heater and the WS heater.

Embodiments of the present disclosure will now be described with reference to the drawings. In the following embodiments, the same or equivalent parts are denoted by the same reference numerals, and the description thereof will be omitted.

### First Embodiment

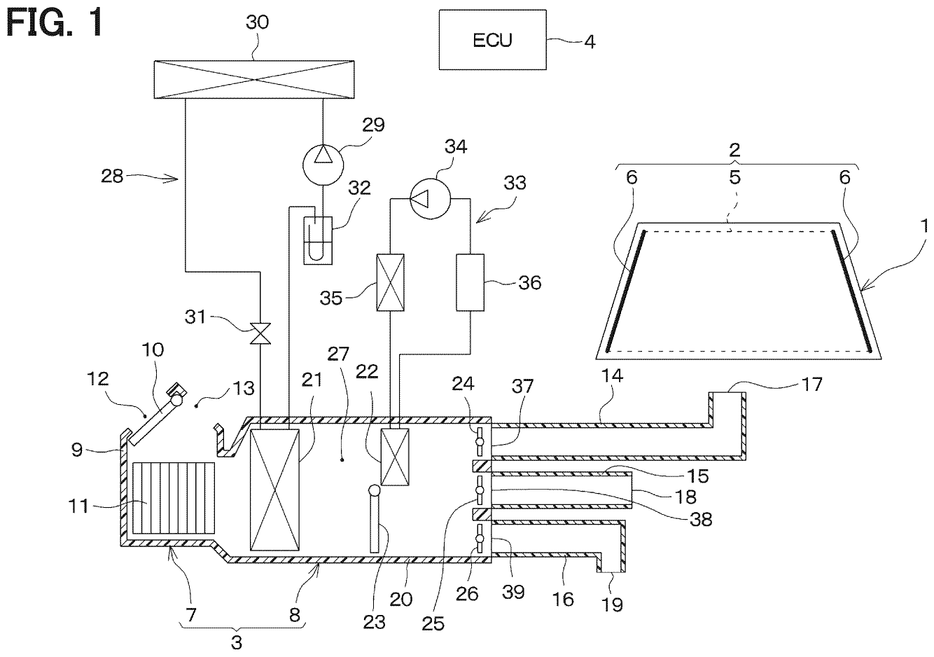

The first embodiment will be described with reference to FIGS. 1 to 4. The vehicle air conditioning system of the first embodiment is installed in vehicles which cannot utilize engine exhaust heat or in which utilization of engine exhaust heat is limited, such as electric vehicles, fuel cell vehicles, hybrid vehicles, plug-in hybrid vehicles and the like. The vehicle air conditioning system is capable of air-conditioning a vehicle cabin and defogging a windshield 1 (hereinafter referred to as “WS 1”). In the present disclosure, defogging may include not only preventing window fogging but also clearing window fogging by deicing, demisting, and the like.

As shown in FIG. 1, the vehicle air conditioning system includes a WS heater 2, an air conditioner 3, an air conditioning ECU 4, and the like.

The WS heater 2 is a transparent electric heater provided on the WS 1 of the vehicle. The WS heater 2 includes a transparent conductive film 5 provided in a light-transmitting region of the WS 1 and a plurality of electrode portions 6 electrically connected to the transparent conductive film 5. The WS heater 2 generates heat when energized, and is capable of directly heating the light-transmitting region of the WS 1.

The air conditioner 3 includes a blower unit 7 and an air conditioning unit 8. The blower unit 7 includes a blower unit case 9, an inside/outside air switching door 10, a blower 11, and the like, and is capable of adjusting a ratio of an amount of introduction of outside air and an amount of circulation of inside air. The blower unit case 9 is provided with an outside air inlet port 12 for sucking outside air and an inside air inlet port 13 for sucking inside air. The inside/outside air switching door 10 opens and closes the outside air inlet port 12 and the inside air inlet port 13. Specifically, the inside/outside air switching door 10 adjusts an opening area of the outside air inlet port 12 and an opening area of the inside air inlet port 13. In such manner, the inside/outside air switching door 10 can adjust an amount of outside air sucked into the blower unit case 9 from the outside air inlet port 12 and an amount of inside air sucked into the blower unit case 9 from the inside air inlet port 13. The blower 11 is, for example, a centrifugal blower. As the blower 11 rotates, air is sucked into the blower unit case 9 through the outside air inlet port 12 and the inside air inlet port 13, flows through the air conditioning unit 8 and ducts 14, 15, and 16, and is blown out from each of air outlet ports 17, 18, and 19 provided in the vehicle cabin.

The air conditioning unit 8 includes an air conditioning unit case 20, a cooling heat exchanger 21, a heating heat exchanger 22, an air mix door 23, and a plurality of mode switching doors 24, 25, 26, and the like. An air passage 27 is formed inside the air conditioning unit case 20. The cooling heat exchanger 21 provided in the air passage 27 is an evaporator that constitutes a part of a vapor compression refrigeration cycle 28. The refrigeration cycle 28 includes a compressor 29, a condenser 30, an expansion valve 31, an evaporator as the cooling heat exchanger 21, an accumulator 32, and the like, which are connected by refrigerant piping. The gas-phase refrigerant compressed by the compressor 29 exchanges heat with outside air in the condenser 30 to become a liquid-phase refrigerant, and then is reduced in pressure and expanded as it passes through the expansion valve 31, becoming a two-phase gas-liquid refrigerant and flowing into the evaporator (i.e., the cooling heat exchanger 21). The refrigerant that has evaporated in the evaporator by heat exchange with the air flowing through the air passage 27 passes through the accumulator 32, and is sucked into the compressor 29. The evaporator exchanges heat between the refrigerant flowing inside a tube and the air flowing through the air passage 27, thereby cooling the air flowing through the air passage 27.

The heating heat exchanger 22 is provided in the air passage 27 downstream of the cooling heat exchanger 21. The heating heat exchanger 22 is a heat exchanger that constitutes a part of a water circuit 33. The water circuit 33 is configured by connecting a water pump 34, an electric heater as an air conditioning heater 35, the heating heat exchanger 22, a reservoir tank 36, and the like with water piping. Water is circulated through the water circuit 33 by the drive of the water pump 34. The air conditioning heater 35 is an electric heater, and, for example, a PCT heater is adopted. PCT stands for Positive Temperature Coefficient. The water heated by the air conditioning heater 35 exchanges heat with the air flowing through the air passage 27 when flowing through the heating heat exchanger 22, thereby heating the air flowing through the air passage 27. Therefore, the electric heater serving as the air conditioning heater 35 generates heat when energized, and indirectly heats the air flowing through the air passage 27 of the air conditioning unit 8 via the heating heat exchanger 22.

The air mix door 23 adjusts a flow rate of air passing through the heating heat exchanger 22 in the air passage 27 and a flow rate of air bypassing the heating heat exchanger 22.

The plurality of mode switching doors 24, 25, 26 open and close respective air outlet openings 37, 38, 39 of the air conditioning unit 8. Specifically, a defroster door 24 opens and closes a defroster air outlet opening 37, a face door 25 opens and closes a face air outlet opening 38, and a foot door 26 opens and closes a foot air outlet opening 39. When the defroster door 24 opens the defroster air outlet opening 37, conditioned air is blown out from a defroster air outlet port 17. When the face door 25 opens the face air outlet opening 38, conditioned air is blown out from a face air outlet port 18. When the foot door 26 opens the foot air outlet opening 39, conditioned air is blown out from a foot air outlet port 19.

The air conditioning ECU 4 is composed of a microcomputer including a processor that performs control processing and arithmetic processing, a memory unit such as a ROM and a RAM that stores programs, data and the like, and peripheral circuits. The memory unit includes non-transitory, tangible storage media. The air conditioning ECU 4 performs various control processes and calculation processes based on programs stored in the memory unit, and controls the drive of each of the devices connected to output ports. Specifically, the air conditioning ECU 4 controls the drive of the WS heater 2 and also controls the drive of various parts of the air conditioner 3 including the refrigeration cycle 28 and the water circuit 33.

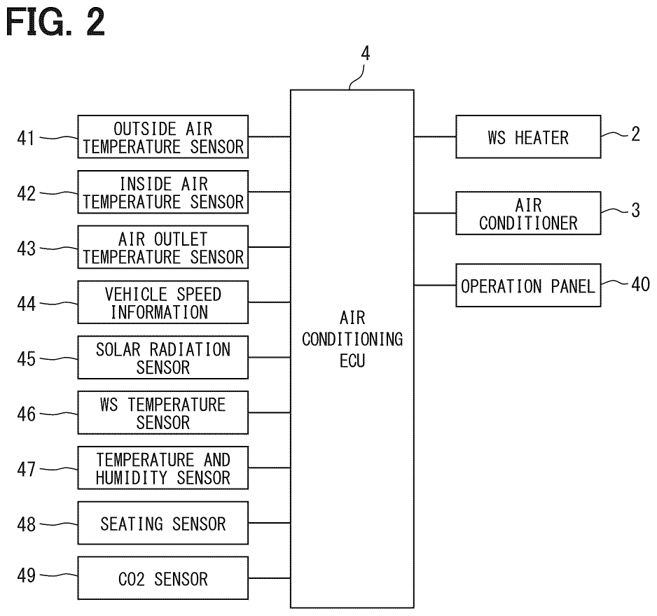

As shown in FIG. 2, signals are input to the air conditioning ECU 4 from various sensors and an operation panel 40. An outside air temperature sensor 41 detects outside air temperature as the temperature outside the vehicle cabin. An inside air temperature sensor 42 detects vehicle cabin temperature. An air outlet temperature sensor 43 detects temperature of the conditioned air blown out from each of the air outlet ports 17, 18, and 19. A vehicle speed sensor 44 detects a speed of the vehicle. A solar radiation sensor 45 detects an amount of solar radiation.

A WS temperature sensor 46 detects temperature of the WS 1. A temperature and humidity sensor 47 is provided in a rear side area of a center in a front-rear direction of the vehicle cabin, and detects temperature and relative humidity. A seating sensor 48 is provided on each seat in the vehicle cabin and detects whether or not an occupant is seated on each seat. A CO2 sensor 49 detects a concentration of carbon dioxide in the vehicle cabin. It is sufficient that at least one of the three types of sensors, the temperature and humidity sensor 47, the seating sensor 48, and the CO2 sensor 49, is provided.

The operation panel 40 is provided with, for example, an air conditioner switch, an auto switch, a temperature setting switch, a blowing mode switch, an inside/outside air selector switch, an air amount selector switch, and the like. The air conditioner switch is a switch that drives the compressor 29 of the refrigeration cycle 28. The auto switch is a switch that performs automatic control of an air conditioning mode. The temperature setting switch is a switch for setting the vehicle cabin temperature. The blowing mode switch is a switch for manually setting a blowing mode. The inside/outside air selector switch is a switch for manually setting an inside/outside air intake mode. The air amount selector switch is a switch for manually setting the air amount of the blower 11. The blowing modes include a face mode, a foot mode, a bi-level mode, a foot/defroster mode, and a defroster mode.

The air conditioning ECU 4 can drive the WS heater 2 so that the WS 1 does not fog up. Specifically, the air conditioning ECU 4 adjusts a heat generation amount of the WS heater 2 so that the relative humidity near a surface of the WS 1 is equal to or lower than a predetermined humidity threshold value. The predetermined humidity threshold value is set to a value less than 100%. The relative humidity in the proximity of the surface of the WS 1 is calculated or estimated based on the relative humidity in the vehicle cabin and the temperature of the WS 1. The relative humidity in the vehicle cabin is detected by the temperature and humidity sensor 47, or is estimated from the number of occupants detected by the seating sensor 48, or the carbon dioxide concentration detected by the CO2 sensor 49. The carbon dioxide concentration in the vehicle cabin corresponds to an amount of breath exhaled by the occupant.

Note that the air conditioning ECU 4 may adjust the heat generation amount of the WS heater 2 according to the outside air temperature, or may adjust the heat generation amount of the WS heater 2 according to the outside air temperature and the relative humidity in the vehicle cabin.

When performing automatic control during heating, the air conditioning ECU 4 drives various parts of the air conditioner 3 including the water circuit 33, such as the air conditioning heater 35 and the blower 11, so that the vehicle cabin temperature reaches the set temperature. Specifically, the air conditioning ECU 4 sets a target blowout temperature and an air amount of the air conditioner 3 based on the set temperature, the outside air temperature, the vehicle cabin temperature, the amount of solar radiation, and the like. Then, the air conditioning ECU 4 controls the amount of electric power supplied to the air conditioning heater 35 and the like, so that the temperature of the conditioned air blown out from each of the air outlet ports 17, 18, 19, i.e., blowout temperature, approaches target blowout temperature. The target blowout temperature is referred to as TAO. TAO stands for Temperature Air Output.

Further, the air conditioning ECU 4 of the present embodiment is configured to be capable of controlling the drive of the WS heater 2 and the air conditioner 3 so that the total consumption of electric power, which is the sum of the electric power consumption of the WS heater 2 and the electric power consumption of the air conditioner 3, approaches a minimum value according to the outside air temperature. In the following description, the total consumption of electric power, which is the sum of the electric power consumption of the WS heater 2 and the electric power consumption of the air conditioner 3, will be simply referred to as a “total consumption of electric power.”

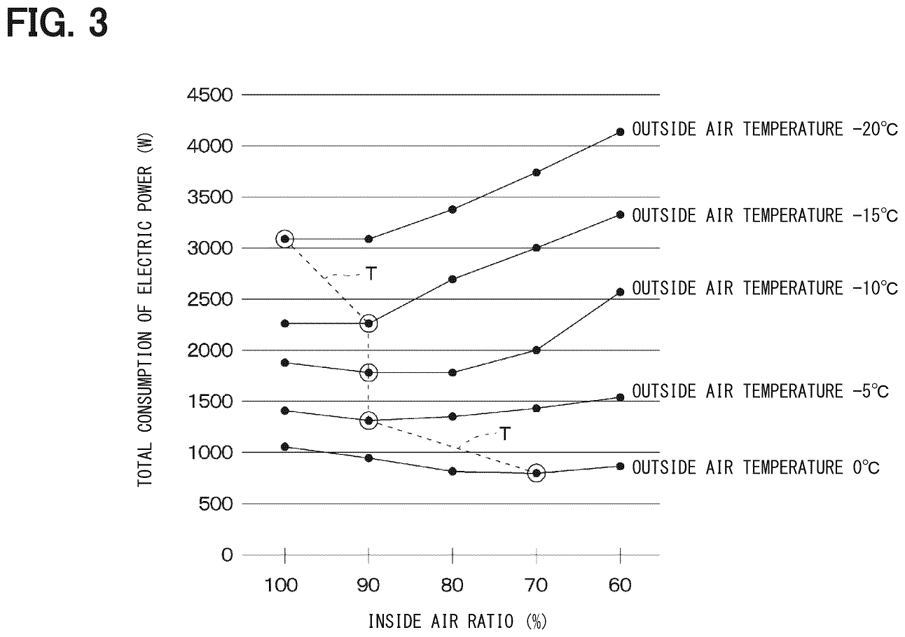

Here, the inventors of the present disclosure conducted a simulation on the relationship between the total consumption of electric power and the inside air ratio, for various values of the outside air temperature, and the results of the simulation are described with reference to the graph in FIG. 3. The inside air ratio is the amount of circulation of inside air relative to the total amount of introduction of outside air and the amount of circulation of inside air.

In such simulation, the air conditioning ECU 4 drives the WS heater 2 so that the WS 1 does not fog up. Further, in automatic control (i.e., auto mode), the air conditioning ECU 4 drives the air conditioning heater 35 and the blower 11 so that the vehicle cabin temperature reaches a set temperature. Further, when the outside air temperature is 0 degree in Celsius or lower, the compressor 29 of the refrigeration cycle 28 is stopped.

The simulation was performed under the following conditions:
Cabin volume: Volume of a typical occupant car (e.g., 410-420 L)
Number of occupants: 5
Travel pattern: 40km/h
Evaluation time: 10,000 seconds
AC heating: Auto (automatic control)
Set temperature: 25 degrees in Celsius
Solar radiation: 0 W

In the graph of FIG. 3, the minimum value of total consumption of electric power is marked with a circle on the graph line for each of the outside air temperatures. In the graph of FIG. 3, when the outside air temperature is −20 degrees in Celsius and the inside air ratio is 100%, the total consumption of electric power is at a minimum value. As the inside air ratio decreases, the total consumption of electric power increases. This is because when the inside air ratio decreases, the amount of introduction of outside air increases, and therefore the energy required to heat the low-temperature outside air by the air conditioning heater 35 increases.

In the graph of FIG. 3, when the outside air temperatures are −15 degrees in Celsius, −10 degrees in Celsius, and −5 degrees in Celsius, the total consumption of electric power reaches a minimum value when the inside air ratio is 90%. That is, the total consumption of electric power is lower when the inside air ratio is 90% than when the inside air ratio is 100%. As the inside air ratio decreases from 90%, the total consumption of electric power increases.

In the graph of FIG. 3, when the outside air temperature is 0 degree in Celsius, the total consumption of electric power reaches a minimum value when the inside air ratio is 70%. That is, the total consumption of electric power is lower when the inside air ratio is 70% than when the inside air ratio is 100%. This is because when the inside air ratio decreases, the amount of introduction of outside air increases, thereby the relative humidity of the air in the vehicle cabin decreases and the energy used by the WS heater 2 to heat the WS 1 decreases. On the other hand, as the amount of introduction of outside air increases, the energy required to heat the outside air by the air conditioning heater 35 increases. However, as the outside air temperature increases, the reduction in energy consumption of the WS heater 2 due to the decrease in the inside air ratio becomes greater than the increase in energy consumption of the air conditioning heater 35 due to the decrease in the inside air ratio, thereby the total consumption of electric power decreases.

As shown by a dashed line T in the graph of FIG. 3, when the outside air temperature is lower than a first predetermined value (for example, lower than −15 degrees in Celsius in FIG. 3), it can be seen that, by increasing the inside air ratio from the one when the outside air temperature is the first predetermined value, the total consumption of electric power approaches the minimum value. Further, when the outside air temperature is higher than a second predetermined value (for example, −5 degrees in Celsius in FIG. 3), it can be seen that, by reducing the inside air ratio than the one when the outside air temperature is at the second predetermined value, the total consumption of electric power approaches the minimum value more. The air conditioning ECU 4 adjusts the inside air ratio so that the total consumption of electric power approaches the minimum value according to the outside air temperature. Note that the value of the inside air ratio at which the total consumption of electric power shown in the graph of FIG. 3 is brought to the minimum value is established under the conditions of the simulation described above, and does not limit the present disclosure. Therefore, the first and second predetermined values are set according to various conditions such as the cabin volume, the number of occupants, the travel pattern, the set temperature, the amount of solar radiation and the like. The first and second predetermined values are set in advance through experiments or the like and stored in memory. Further, the first predetermined value and the second predetermined value are not limited to being different values, and may be set to the same value.

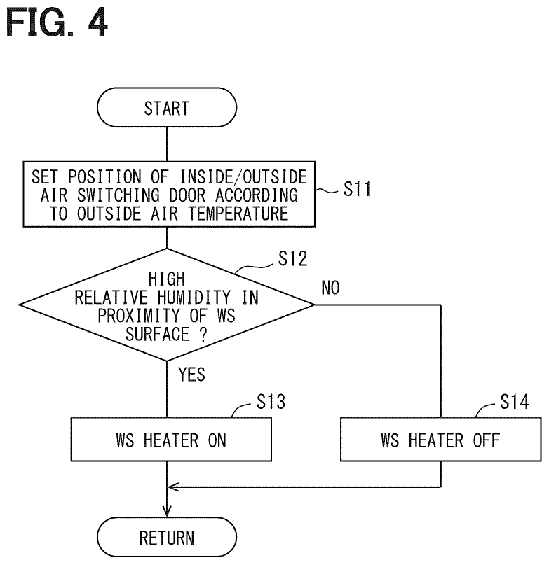

Next, a control process in which the air conditioning ECU 4 of the present embodiment automatically controls heating will be described with reference to the flowchart of FIG. 4. In the following explanation and flowcharts, steps are simply represented as “S.”

When the auto switch is turned on, the air conditioning ECU 4 repeatedly performs the control process shown in the flowchart of FIG. 4 at a predetermined control cycle.

In S11, the air conditioning ECU 4 sets the position of the inside/outside air switching door 10 of the blower unit 7 according to the outside air temperature. That is, the air conditioning ECU 4 sets the position of the inside/outside air switching door 10 to increase the inside air ratio when the outside air temperature is low, and to lower the inside air ratio when the outside air temperature is high, and moves the inside/outside air switching door 10 to the set position. Specifically, as shown in FIG. 3, the air conditioning ECU 4 performs control to increase the inside air ratio in response to a fall in the outside air temperature within a predetermined temperature range, for example. Further, the air conditioning ECU 4 performs control to lower the inside air ratio in response to a rise in the outside air temperature within a predetermined temperature range, for example.

Next, in S12, the air conditioning ECU 4 determines whether the relative humidity in the proximity of the surface of the WS 1 is higher than a predetermined humidity threshold value. Note that, as described above, the predetermined humidity threshold value is set to a value lower than 100%. Further, the relative humidity in the proximity of the surface of the WS 1 is calculated or estimated based on the relative humidity in the vehicle cabin and the temperature of the WS 1. When it is determined that the relative humidity in the proximity of the surface of the WS 1 is higher than the predetermined humidity threshold value, the process proceeds to S13.

In S13, the air conditioning ECU 4 turns on the WS heater 2. In such manner, the WS 1 is heated, thereby preventing water vapor in the air in the vehicle cabin from condensing on the WS 1, thus preventing the windows from fogging up.

On the other hand, when it is determined in S12 that the relative humidity in the proximity of the surface of the WS 1 is equal to or lower than the predetermined humidity threshold value, the process proceeds to S14. In S14, the air conditioning ECU 4 turns off the WS heater 2. As a result, the WS heater 2 does not consume electric power.

After the process of S13 or S14, the air conditioning ECU 4 repeats the processes from S11 again.

The vehicle air conditioning system of the first embodiment described above provides the following advantages.

(1) In the first embodiment, the air conditioning ECU 4 drives the WS heater 2 to prevent the WS 1 from fogging up, drives the air conditioning heater 35 to keep the vehicle cabin temperature at a set temperature, and further drives the blower unit 7 to increase the inside air ratio according to the outside air temperature.

According to the above, when the outside air temperature is low, the air conditioning ECU 4 increases the inside air ratio, thereby making it possible to significantly reduce the energy required to heat the low-temperature outside air by the air conditioning heater 35.

On the other hand, as the inside air ratio increases, the relative humidity in the vehicle cabin increases, and therefore the energy required to heat the WS 1 by the WS heater 2 also increases. However, when the outside air temperature is low, the increase in energy of the WS heater 2 due to an increase in the inside air ratio is smaller than the increase in energy required to heat the low-temperature outside air by the air conditioning heater 35, thereby the total consumption of electric power lowers.

In view of such a situation, when the outside air temperature is high, the air conditioning ECU 4 lowers the inside air ratio, i.e., increases the ratio of the amount of introduction of the outside air, thereby lowering the relative humidity of the air in the vehicle cabin and reducing the energy used by the WS heater 2 to heat the WS 1. On the other hand, as the amount of introduction of outside air increases, the energy required to heat the outside air by the air conditioning heater 35 increases. However, when the outside air temperature is high, the reduction in energy of the WS heater 2 due to the reduction in the inside air ratio is greater than the increase in energy of the air conditioning heater 35 due to the reduction in the inside air ratio, thereby the total consumption of electric power is reduced.

Therefore, the vehicle air conditioning system of the present embodiment can bring the total consumption of electric power closer to the minimum value in response to the outside air temperature by increasing the inside air ratio according to the outside air temperature. Specifically, as shown in FIG. 3, the air conditioning ECU 4 performs control to increase the inside air ratio in response to a fall in the outside air temperature within a predetermined temperature range, for example. Further, the air conditioning ECU 4 performs control to lower the inside air ratio in response to a rise in the outside air temperature within a predetermined temperature range, for example.

(2) In the first embodiment, the air conditioning ECU 4 can estimate the humidity in the vehicle cabin according to the number of occupants or the concentration of carbon dioxide in the vehicle cabin. Further, when the relative humidity of the surface of the WS 1 calculated based on (i) the estimated humidity in the vehicle cabin and (ii) the temperature of the WS 1 detected by the WS temperature sensor 46 is higher than a predetermined humidity threshold value, the air conditioning ECU 4 controls the WS heater 2 to heat the WS 1. In such manner, the consumption of electric power by the WS heater 2 is reducible when the humidity in the vehicle cabin is low. As a result, the total consumption of electric power is reducible.

(3) In the first embodiment, the temperature and humidity sensor 47 may be provided in the rear side area of the center of the vehicle cabin in the front-rear direction. In such case, when the relative humidity of the surface of the WS 1 calculated based on the temperature and relative humidity detected by the temperature and humidity sensor 47 and the temperature of the WS 1 detected by the WS temperature sensor 46 is higher than a predetermined humidity threshold value, the air conditioning ECU 4 controls the WS heater 2 to heat the WS 1.

According to the above, generally, a time lag may occur in the detected value of the temperature and humidity sensor 47. On the other hand, the area in the vehicle cabin on a rear side is an area where the relative humidity is likely to be higher than the area near the WS 1 where the WS heater 2 is provided. Therefore, by (A) detecting the temperature and relative humidity of the area using the temperature and humidity sensor 47, and (B) considering the difference between (i) the likelihood of window fogging in the area near the WS 1 and (ii) the likelihood of window fogging in the area toward the rear of the vehicle cabin as a safety factor, it becomes possible to more accurately control the drive of the WS heater 2. Therefore, the energy consumed by the WS heater 2 is reducible, and as a result, the total consumption of electric power is reducible.

(4) In the first embodiment, the air conditioning ECU 4 controls the drive of the WS heater 2 and the air conditioner 3 so that the total consumption of electric power approaches the minimum value according to the outside air temperature.

According to the above, the air conditioning ECU 4 uses both of the WS heater 2 and the air conditioning heater 35, and, when the outside air temperature is low, by increasing the inside air ratio, the total consumption of electric power can be brought closer to the minimum value according to the outside air temperature.

(5) In the first embodiment, the air conditioning heater 35 is an electric heater that heats air using electric power.

According to the above, an electric heater is exemplified as the air conditioning heater 35 provided in the air conditioner 3 mounted on an electric vehicle, a fuel cell vehicle, a hybrid vehicle, a plug-in hybrid vehicle, or the like.

(6) In the first embodiment, the air conditioning ECU 4 performs control to drive the blower unit 7 to increase the inside air ratio according to the outside air temperature, at least when the outside air temperature is 0 degree in Celsius or lower.

According to the above, when the outside air temperature is below 0 degree in Celsius, which is a situation in which the WS 1 highly likely fogs up and the refrigeration cycle 28 is stopped, the control of the present embodiment is effective.

### Second Embodiment

The following describes the second embodiment of the present disclosure. The second embodiment will be described with respect to the configuration of the blower unit 7 in comparison with the first embodiment, and since the rest is the same as the first embodiment, only the parts different from the first embodiment will be described.

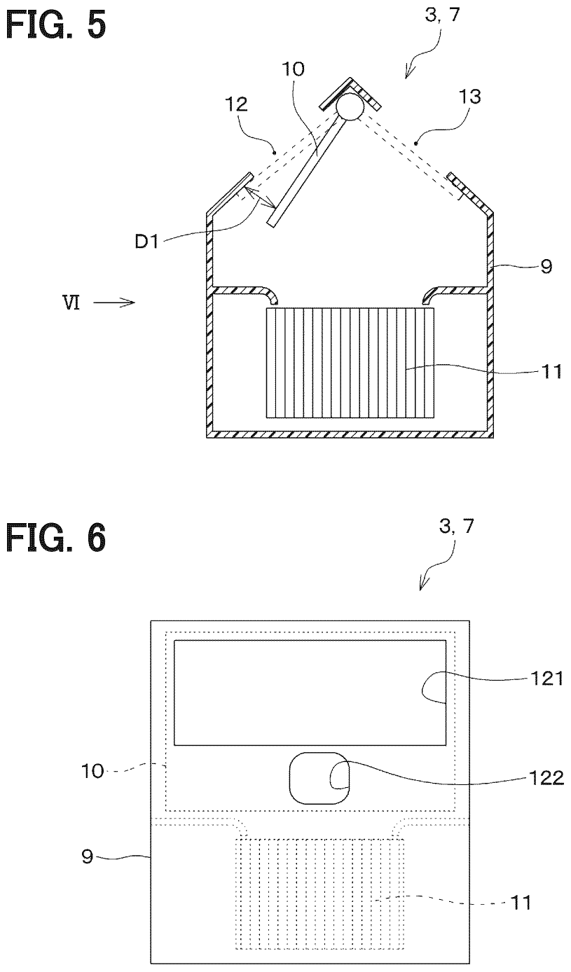

As shown in FIG. 5, the blower unit 7 of the second embodiment, like the first embodiment, includes a blower unit case 9, an inside/outside air switching door 10, a blower 11, and the like, and is capable of adjusting a ratio of an amount of introduction of outside air and an amount of circulation of inside air. Note that the inside/outside air switching door 10 is not limited to a plate door shown in FIG. 5, but various doors such as a rotary door, a slide door, a film door or the like can be used.

Incidentally, when an outside air inlet port 12 is slightly opened by the inside/outside air switching door 10, the blower unit 7 may generate a whistling noise, e.g., “air rushing sound” or the like.

Therefore, in the second embodiment, when inside air and outside air are simultaneously sucked into the blower unit case 9, the air conditioning ECU 4 sets the position of the inside/outside air switching door 10 so that an abnormal noise generated by the outside air inlet port 12 is within a range that the occupants cannot recognize as an abnormal noise, as shown by an arrow D1 in FIG. 5. That is, when inside air and outside air are simultaneously sucked into the blower unit case 9, the air conditioning ECU 4 sets the position of the inside/outside air switching door 10 in a range wider than the one indicated by the arrow D1 in FIG. 5.

The vehicle air conditioning system according to the second embodiment described above can suppress the generation of abnormal noise when the air conditioning ECU 4 performs control to lower the inside air ratio.

### Third Embodiment

The third embodiment will be described. The third embodiment differs from the first and second embodiments in that some of the configuration of the blower unit 7 is changed, but the rest is the same as the first and second embodiments, thus only the parts that differ from the first and second embodiments will be described. FIG. 6, which is referred to in the third embodiment, is a view corresponding to the view seen in the direction of an arrow VI in FIG. 5.

As shown in FIG. 6, in a blower unit 7 of the third embodiment, a first outside air inlet port 121, a second outside air inlet port 122, and an inside air inlet port 13 are provided in a blower unit case 9. In addition, in FIG. 6, the inside air inlet port 13 is not shown because it is provided on an opposite side of a rotary shaft of a blower 11 with respect to the first outside air inlet port 121. An inside/outside air switching door 10 can open and close the first outside air inlet port 121, the second outside air inlet port 122, and the inside air inlet port 13. Note that multiple inside/outside air switching doors 10 may be provided corresponding to the first outside air inlet port 121 and the second outside air inlet port 122, and the first outside air inlet port 121 and the second outside air inlet port 122 may be configured to be individually openable and closable. The inside/outside air switching door 10 may be any of various doors, such as a rotary door, a sliding door or the like.

Here, the second outside air inlet port 122 has an opening area smaller than that of the first outside air inlet port 121, and has an aspect ratio that is within a range in which the abnormal noise generated when the inside/outside air switching door 10 opens the second outside air inlet port 122 cannot be recognized as an abnormal noise by the occupants. Note that the shape of the second outside air inlet port 122 is not limited to the shape illustrated in FIG. 6, and various other shapes may be used, such as a circle, an ellipse, a polygon, or a combination thereof. Further, the number of the second outside air inlet ports 122 is not limited to one, and multiple second outside air inlet ports 122 may be provided. Further, the first outside air inlet port 121 and the second outside air inlet port 122 may be formed as a single continuous opening.

An air conditioning ECU 4 sets the position of the inside/outside air switching door 10 so that the inside air inlet port 13 and the second outside air inlet port 122 are open when inside air and outside air are simultaneously sucked into the blower unit case 9. In such situation, the air conditioning ECU 4 sets the position of the inside/outside air switching door 10 so that the first outside air inlet port 121 is not opened within a range smaller than the range indicated by the arrow D1 in FIG. 5 described in the second embodiment. When both of inside air and outside air are simultaneously sucked into the blower unit case 9, the air conditioning ECU 4 may set the position of the inside/outside air switching door 10 so that the first outside air inlet port 121 is opened in a range greater than the range indicated by the arrow D1 in FIG. 5 described in the second embodiment.

The aspect ratio of the second outside air inlet port 122 of the blower unit 7 of the third embodiment described above is set within a range in which the noise generated when taking in outside air is not recognizable to the occupants as an abnormal noise. Therefore, when the air conditioning ECU 4 performs control to lower the inside air ratio, the generation of abnormal noise is suppressed by opening the inside air inlet port 13 and the second outside air inlet port 122 without slightly opening the first outside air inlet port 121 in a range of causing the occupants to recognize the abnormal noise. When the air conditioning ECU 4 performs control to lower the inside air ratio, the first outside air inlet port 121 is allowed to be opened to an extent that prevents the occupants from recognizing the abnormal noise.

Further, in the third embodiment, the amount of reduction of the inside air ratio can be adjusted more finely than in the second embodiment.

### Fourth Embodiment

The following describes the fourth embodiment of the present disclosure. The fourth embodiment explains a defogging control of a WS 1 performed by an air conditioning ECU 4 with respect to the first embodiment and the like, and since the rest is the same as the first embodiment and the like, only the parts different from the first embodiment and the like will be described.

The air conditioning system of Patent Document 1 described in the above-described [Prior Art Document] performs control to heat the WS 1 using a WS heater 2 without driving an air conditioner 3 in a defroster mode when the conditions for fogging on the WS 1 are satisfied.

However, with regard to the air conditioning system of Patent Document 1, the inventors of the present disclosure discovered an issue in that if an already fogged up WS 1 is clearing by driving only the WS heater 2, it results in an increase in the consumption of electric power due to the driving of the WS heater 2. Such a situation is caused because, when trying to clear the already fogged up WS 1 by driving only the WS heater 2, the water vapor evaporated from the WS 1 stays in the proximity of the surface of the WS 1, thereby increasing the relative humidity in the proximity of the surface of the WS 1 and making it difficult for the fogging on the WS 1 to evaporate.

Therefore, the air conditioning ECU 4 of the fourth embodiment changes a defogging control method for the WS 1 according to whether the WS 1 to be defogged is in a fogged state or is in a non-fogged state.

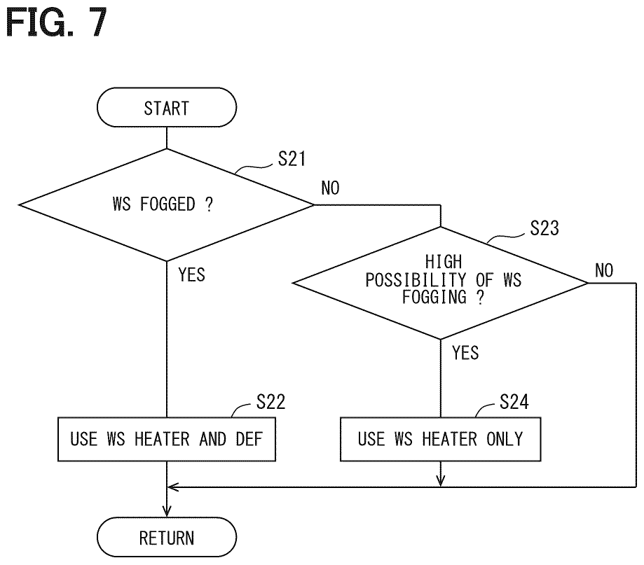

The defogging control of the WS 1 performed by the air conditioning ECU 4 of the fourth embodiment will be described with reference to the flowchart of FIG. 7.

In S21, the air conditioning ECU 4 determines whether the WS 1 is already fogged up. This determination can be made, for example, based on information obtained from an in-vehicle camera installed in the vehicle cabin. The in-vehicle camera captures images of the outside of the vehicle from inside the vehicle via the WS 1. Therefore, the air conditioning ECU 4 can determine whether the WS 1 is already fogged up based on image information captured by the in-vehicle camera. When it is determined that WS 1 is already fogged up, the process proceeds to S22.

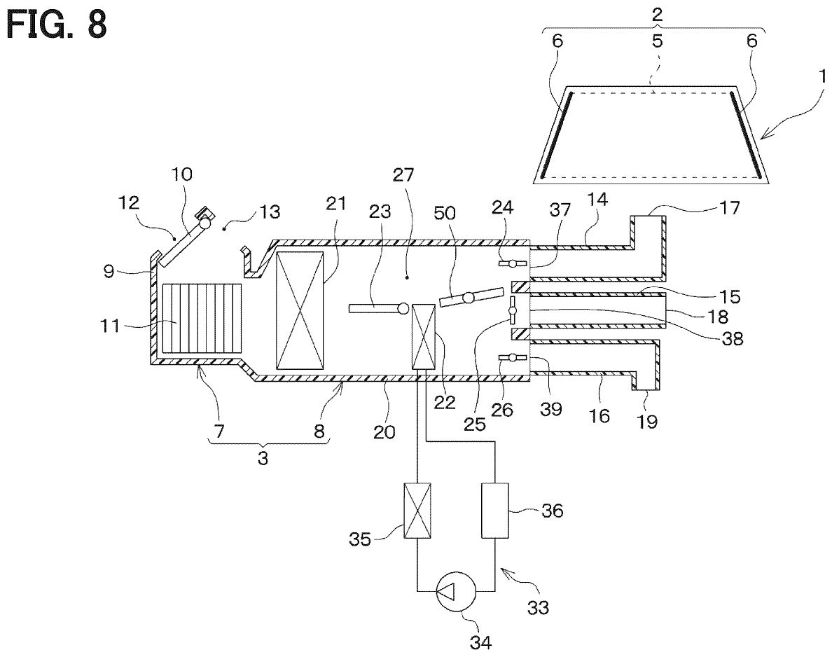

In S22, the air conditioning ECU 4 drives the WS heater 2 and drives the air conditioner 3 in the defroster mode (DEF). In such manner, it is possible to prevent the relative humidity in the proximity of the surface of the WS 1 from increasing due to the airflow blown out from the defroster air outlet port 17 toward the WS 1, while heating the WS 1 with the WS heater 2 and efficiently evaporating the fogging on the WS 1. Therefore, the total consumption of electric power is reducible. When using the defroster mode and the WS heater 2 together, the defroster mode only requires an airflow to prevent an increase in the relative humidity in the proximity of the WS 1, which is achievable by blowing air not heated by the air conditioning heater 35 toward the WS 1. In such case, the air conditioning ECU 4 drives, for example, an intermediate door 50, an air mix door 23, and a plurality of mode switching doors 24, 25, 26 provided in the air conditioner 3, as shown in FIG. 8. In such state, the air conditioner 3 blows unheated air from the defroster air outlet port 17 toward the WS 1, which is achieved by controlling the air mix door 23 to cause the air to bypass the heating heat exchanger 22. Further, the air conditioner 3 also heats air passing through the heating heat exchanger 22 with the air conditioning heater 35 and blows out the heated air from the foot air outlet port 19.

On the other hand, when it is determined in S21 that the WS 1 is not fogged up, the process proceeds to S23. In S23, the air conditioning ECU 4 determines whether or not there is a high possibility that the WS 1 will fog up. Such a determination can be made, for example, by determining whether the relative humidity in the proximity of the surface of the WS 1 is higher than a predetermined humidity threshold value. Such a determination may be made, for example, based on whether the outside air temperature is lower than a predetermined temperature threshold value, or based on whether the relative humidity in the vehicle cabin is higher than a predetermined humidity threshold value. When it is determined that there is a high possibility that the WS 1 will fog up, the process proceeds to S24.

In S24, the air conditioning ECU 4 drives the WS heater 2. In such manner, the WS 1 is prevented from fogging up. When defogging the non-fogged WS 1, consumption of electric power is reducible by directly heating the WS 1 with the WS heater 2, compared to using the defroster mode.

On the other hand, when it is determined in S23 that there is a low possibility that the WS 1 will fog up, the air conditioning ECU 4 turns off the WS heater 2, and drives the air conditioner 3 in a mode other than the defroster mode or stops the air conditioner 3. Then, the air conditioning ECU 4 repeatedly performs the processes of S21 to S24 at a predetermined control cycle.

The vehicle air conditioning system of the fourth embodiment described above provides the following advantages.

(1) In the fourth embodiment, when the WS 1 in the fogged state is defogged, the air conditioning ECU 4 performs control to perform the defroster mode, and to heat the WS 1 by the WS heater 2. On the other hand, when defogging the WS 1 in the non-fogged state, the air conditioning ECU 4 performs control to heat the WS 1 with the WS heater 2 without performing the defroster mode.

According to the above, when clearing the WS 1 that is already fogged up, it is possible to prevent the relative humidity in the proximity of the surface of the WS 1 from increasing due to the airflow in the defroster mode, while heating the WS 1 with the WS heater 2, thereby efficiently evaporating the fog on the WS 1. Therefore, the total consumption of electric power is reducible.

On the other hand, when defogging the WS 1 in the non-fogged state, the WS heater 2 can directly heat the WS 1, thereby reducing consumption of electric power compared to using the defroster mode.

(2) In the fourth embodiment, when the air conditioning ECU 4 defogs the WS 1 in a fogged state, the air conditioning ECU 4 can perform the defroster mode, in which the WS 1 is heated by the WS heater 2 and unheated air (i.e., air not heated by the air conditioning heater 35) is blown toward the WS 1.

According to the above, when clearing the WS 1 in the fogged state, the WS 1 is heated by the WS heater 2, thereby (i) not requiring the airflow in the defroster mode to be a warm airflow, and (ii) only requiring an airflow to prevent an increase in the relative humidity in the proximity of the WS 1. Therefore, the total consumption of electric power is reducible and the WS 1 can be cleared from fogging in a short time.

(3) Further, in the fourth embodiment, when the occupants turns on (i) the defroster mode switch on the operation panel 40, or (ii) the foot/defroster mode, the defroster mode or the foot/defroster mode may be performed and the WS 1 may be heated by the WS heater 2.

According to the above, by using the airflow in the defroster mode and the WS heater 2 in combination, the window can be cleared in a short time. Further, the conditioned air from the foot air outlet port 19 can heat the vehicle cabin, improving comfort.

### Modification of Fourth Embodiment

A modification of the fourth embodiment will now be described. In S24 of the fourth embodiment, when defogging the WS 1 in a non-fogged state, the air conditioning ECU 4 performs control to heat the WS 1 with the WS heater 2 without performing the defroster mode.

In contrast, in a modification of the fourth embodiment, when defogging the WS 1 in a non-fogged state, control is performed in which heating the WS 1 by using the WS heater 2 and a small amount of air is allowed to flow from the defroster air outlet port 17 as long as the air amount has substantially little effect on consumption of electric power. That is, in such case, it is not necessary to stop the airflow in the defroster mode.

To summarize the fourth embodiment and the modification of the fourth embodiment, when defogging the WS 1 in a non-fogged state, the air conditioning ECU 4 can perform control in which the airflow in the defroster mode is stopped or the amount of airflow is reduced and the WS 1 is heated with the WS heater 2.

### Fifth Embodiment

The fifth embodiment of the present disclosure is described. In the fifth embodiment, a defogging control of a side window performed by an air conditioning ECU 4 is described in comparison with the first embodiment, and the like, and since the rest is the same as the first embodiment and the like, only the parts different from the first embodiment and the like will be described.

The air conditioning system of Patent Document 1 in the above-mentioned [Prior Art Document] describes the defogging of the WS 1, but does not describe the defogging of the side windows.

The inventors of the present disclosure have found that when defogging of the WS 1 is performed only by the WS heater 2 and the inside air ratio is increased, fogging occurs on the side windows. When the side windows is fogged, it can cause travel safety issues.

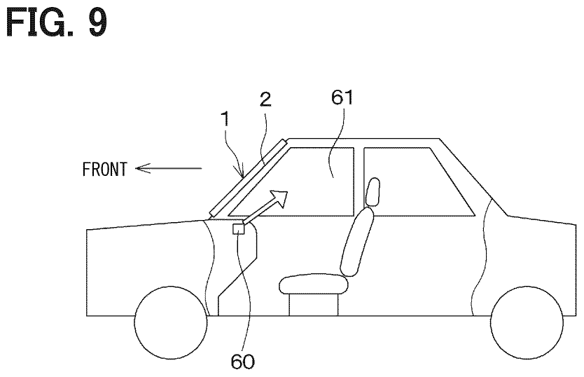

Therefore, the air conditioning ECU 4 of the fifth embodiment is configured to perform control to lower the inside air ratio, that is, to increase the amount of introduction of outside air, when there is a high possibility that the side windows will fog up. In such case, the air conditioning ECU 4 may blow conditioned air toward a side window 61 from a side defroster outlet port 60 provided in the vehicle cabin, as shown in FIG. 9.

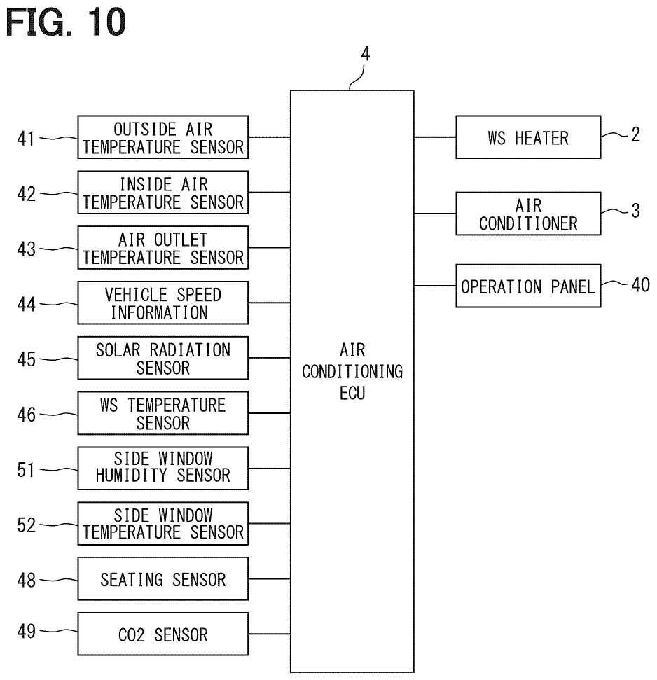

As shown in FIG. 10, the air conditioning ECU 4 of the fifth embodiment is configured to receive signals from a side window humidity sensor 51 and a side window temperature sensor 52 in addition to the various sensors described in the first embodiment. The side window humidity sensor 51 is provided on a cabin side of the side window 61 and detects the humidity in the proximity of the surface of the side window 61. The side window temperature sensor 52 detects temperature of the side window 61. It is sufficient that at least one of the three types of sensors, the side window humidity sensor 51, the seating sensor 48, and the CO2 sensor 49, is provided.

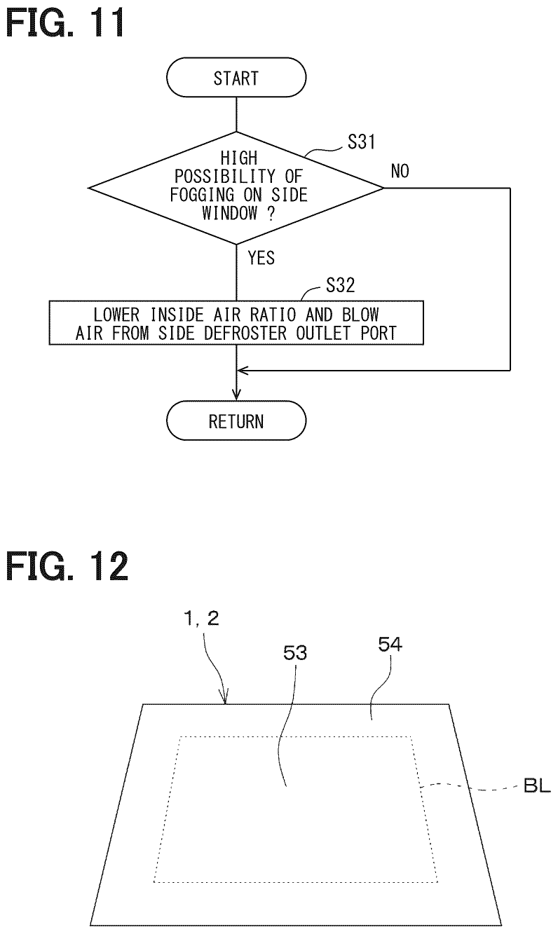

Next, the defogging control of the side window 61 performed by the air conditioning ECU 4 of the fifth embodiment will be described with reference to the flowchart of FIG. 11.

In S31, the air conditioning ECU 4 determines whether or not there is a high possibility that the side window 61 will fog up. Such a determination can be made, for example, by determining whether a value obtained by subtracting a dew point temperature of the side window 61 from the temperature of the side window 61 is smaller than a predetermined temperature threshold value. Note that the air conditioning ECU 4 may determine whether there is a high possibility that the side window 61 will fog up based on whether the outside air temperature is lower than a predetermined temperature threshold value or whether the relative humidity in the vehicle cabin is higher than a predetermined humidity threshold value.

The dew point temperature of the side window 61 is calculated based on the relative humidity of the side window 61 on the cabin side of the vehicle and the temperature of the side window 61. The relative humidity on the cabin side of the side window 61 is detected by the side window humidity sensor 51, or is estimated from the number of occupants detected by the seating sensor 48, or the carbon dioxide concentration detected by the CO2 sensor 49. When it is determined that there is a high possibility that the side window 61 will fog up, the process proceeds to S32.

In S32, the air conditioning ECU 4 drives the blower unit 7 to lower the inside air ratio. Alternatively, the air conditioning ECU 4 may perform a side defroster mode while lowering the inside air ratio. The side defroster mode is a mode in which conditioned air is blown out from the side defroster outlet port 60 toward the side window 61. In such manner, it is possible to prevent the side window 61 from fogging up.

On the other hand, when it is determined in S31 that there is a low possibility that the side window 61 will fog up, the air conditioning ECU 4 sets the inside air ratio as described in the first embodiment, and drives the air conditioner 3 in a mode other than the side defroster mode or stops the air conditioner 3. Then, the air conditioning ECU 4 repeatedly performs the processes of S31 to S32 at a predetermined control cycle.

The vehicle air conditioning system of the fifth embodiment described above provides the following advantages.

(1) In the fifth embodiment, when the value obtained by subtracting the dew point temperature of the side window 61 from the temperature of the side window 61 becomes smaller than a predetermined threshold value, the air conditioning ECU 4 drives the blower unit 7 to lower the inside air ratio.

According to the above, when the inside air ratio is increased when the WS heater 2 is driven, the WS heater 2 can prevent the window of the WS 1 from fogging up, but the side window 61 may fog up. Therefore, when the temperature of the side window 61 approaches the dew point temperature, the inside air ratio is reduced, that is, the amount of introduction of outside air is increased, thereby lowering the relative humidity of the air in the vehicle cabin and preventing the side window 61 from fogging up.

(2) In the fifth embodiment, when the value obtained by subtracting the dew point temperature of the side window 61 from the temperature of the side window 61 of the vehicle becomes smaller than a predetermined threshold value, the air conditioning ECU 4 drives the blower unit 7 to lower the inside air ratio and performs the side defroster mode.

According to the above, by reducing the relative humidity of the air in the vehicle cabin, and, by performing the side defroster mode, the side window 61 is reliably defogged.

(3) In the fifth embodiment, the air conditioning ECU 4 calculates the dew point temperature of the side window 61 based on the relative humidity of the side window 61 on the cabin side and the temperature of the side window 61.

According to the above, the air conditioning ECU 4 can prevent the side window 61 from fogging up, by calculating the dew point temperature of the side window 61 and performing the above-described control.

(4) In the fifth embodiment, the air conditioning ECU 4 estimates the dew point temperature of the side window 61 based on (i) the relative humidity in the vehicle cabin, which is estimated based on the number of occupants or the carbon dioxide concentration in the vehicle cabin, and (ii) the temperature of the side window 61.

According to the above, the air conditioning ECU 4 can prevent the side window 61 from fogging up by estimating the dew point temperature of the side window 61 and performing the above-described control.

### Sixth Embodiment

The following describes the sixth embodiment of the present disclosure. The sixth embodiment differs from the first embodiment in that the configuration of the WS heater 2 is partially changed, but the rest is the same as the first embodiment, thereby only the parts different from the first embodiment will be described.

The inventors of the present disclosure have found that in the WS 1, window fogging is more likely to occur in an outer periphery portion 54 than in a central portion 53. Therefore, when the heat generation amount per unit area of the central portion 53 of the WS heater 2 is made the same as the heat generation amount per unit area of the outer periphery portion 54, the heat generation amount of the central portion 53 will be wasted, and consumption of electric power may increase.

Therefore, as shown in FIG. 12, the WS heater 2 of the sixth embodiment is configured so that a larger electric current can be passed through the outer periphery portion 54 of the WS 1 than through the central portion 53 of the WS 1. That is, the WS heater 2 is configured such that the electrical resistance value per unit area of the outer periphery portion 54 of the WS 1 is lower than the electrical resistance value per unit area of the central portion 53 of the WS 1. As a result, the WS heater 2 generates a greater amount of heat per unit area in the outer periphery portion 54 of the WS 1 than in the central portion 53 of the WS 1. In FIG. 12, for the sake of convenience, an example of a boundary between the central portion 53 of the WS 1 and the outer periphery portion 54 of the WS 1 is shown by a broken line BL, but the boundary is not limited to such a configuration. For example, the WS heater 2 may be configured so that the electrical resistance value per unit area gradually decreases from the central portion 53 of the WS 1 toward the outer periphery portion 54 of the WS 1.

In the sixth embodiment described above, the WS heater 2 is configured such that the electrical resistance value per unit area of the outer periphery portion 54 of the WS 1 is lower than the electrical resistance value per unit area of the central portion 53 of the WS 1.

According to the above, by passing a large amount of electric current through the outer periphery portion 54 of the WS 1, which is prone to window fogging, and by increasing the amount of heat generated, the defogging performance can be maintained, and further, by reducing the electric current through the central portion 53 of the WS 1, the consumption of electric power of the WS heater 2 is reducible.

### Seventh Embodiment

The seventh embodiment of the present disclosure is described. The seventh embodiment is the same as the first embodiment, except that the functions of an air conditioning ECU 4 are added. Therefore, only the differences from the first embodiment will be described.

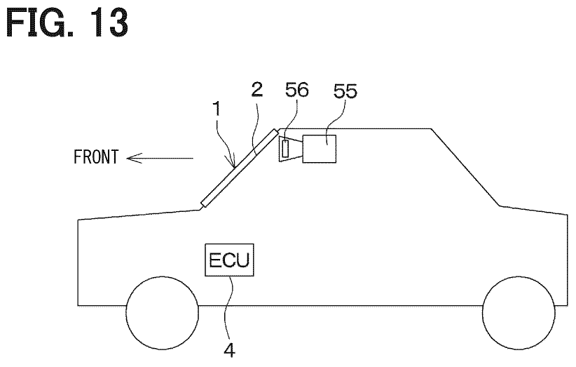

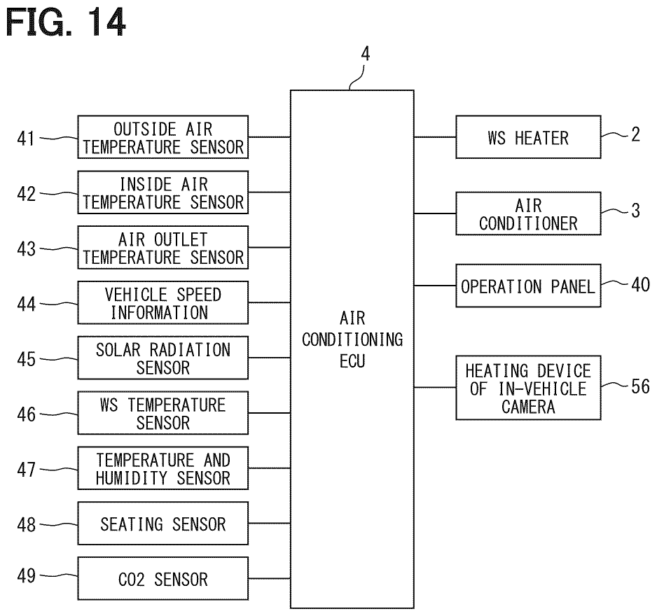

As shown in FIGS. 13 and 14, in the seventh embodiment, an in-vehicle camera 55 is provided in the vehicle cabin. An in-vehicle camera 55 captures images of the outside of the vehicle from inside of the vehicle cabin via the WS 1. The in-vehicle camera 55 is provided with a heating device 56 for heating a lens of the in-vehicle camera 55 itself. The heating device 56 is driven and controlled by the air conditioning ECU 4. That is, the air conditioning ECU 4 of the seventh embodiment is configured to be capable of driving and controlling the heating device 56 of the in-vehicle camera 55 in addition to the WS heater 2 and the air conditioner 3.

In the seventh embodiment described above, the heating device 56 that heats the lens of the in-vehicle camera 55 is driven and controlled using the air conditioning ECU 4, thereby reducing the number of parts in the ECU and reducing costs.

### Eighth Embodiment

The eighth embodiment will be described. The eighth embodiment is the same as the first embodiment and the like, except that a method for determining window fogging of the WS 1 is added, and therefore only the parts that are different from the first embodiment will be described.

The inventors of the present disclosure have discovered a problem in that when determining that window fogging has occurred on a WS 1 based on image information captured by an in-vehicle camera 55, the visibility of the occupants is temporarily impaired. When the WS 1 is fogged, it may cause a problem in terms of travel safety, and electric power will be consumed to clear the fogging on the WS 1.

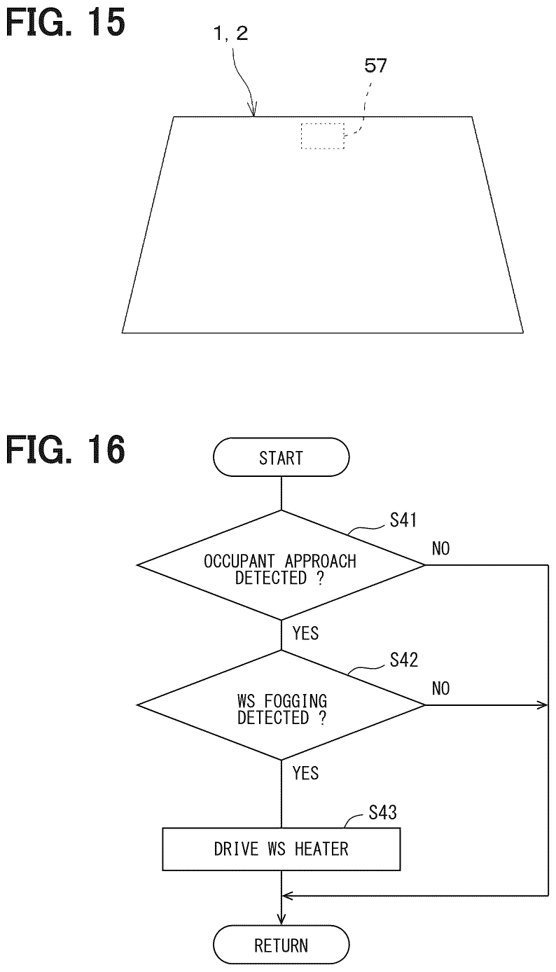

Therefore, in the eighth embodiment, as shown in FIG. 15, a part 57 is provided as a part of the WS 1, which is a part (i) difficult to heat by using a WS heater 2 and (ii) easily causing window fogging. The part 57 where window fogging is easily caused is set at a position within the WS 1 that does not obstruct the visibility of the occupants. In addition, methods for making the window more susceptible to fogging may include increasing the resistance value of the WS heater 2 at the part 57, decreasing the electric current value and the like.

Thus, when having window fogging at the part 57 provided on the WS 1 where window fogging is easily caused, the part 57 is captured by the in-vehicle camera 55 to detect the window fogging, and the WS heater 2 is driven.

In the eighth embodiment described above, the defogging control can be started without temporarily impairing the visibility of the occupants.

### Ninth Embodiment

The ninth embodiment will be described. The ninth embodiment is the same as the first embodiment, except that defogging control is added to the first embodiment, and therefore only the parts different from the first embodiment will be described.

An air conditioning ECU 4 of the ninth embodiment incorporates a control to start driving a WS heater 2 before an occupant gets into the vehicle when a WS 1 is fogged up while the vehicle is stopped.

The defogging control performed by the air conditioning ECU 4 of the ninth embodiment will be described with reference to the flowchart of FIG. 16. The process of such control is repeatedly performed while the vehicle is stopped and no occupant is seated in the driver's seat.

In S41, the air conditioning ECU 4 determines whether or not an occupant has approached the vehicle from outside the vehicle. Such a determination can be made, for example, by analyzing image information captured by an in-vehicle side camera that captures an area including sides of the vehicle. Alternatively, such a determination can be made by receiving radio waves transmitted from a transmitter attached to a smart key carried by the occupant with a receiver mounted on the vehicle. When it is determined that an occupant has approached the vehicle from outside the vehicle, the process proceeds to S42.

In S42, the air conditioning ECU 4 determines whether the WS 1 is fogged up. Whether or not the WS 1 is fogged up is determinable by, for example, analyzing image information captured by an in-vehicle camera 55 that captures an image of the outside of the vehicle through the WS 1 from inside the vehicle. When it is determined that the WS 1 is fogged up, the process proceeds to S43.

In S43, the air conditioning ECU 4 drives the WS heater 2. As a result, the drive of the WS heater 2 is started before an occupant gets into the vehicle, and the WS 1 can be defogged. At this time, the air conditioning ECU 4 may perform control to heat the WS 1 with the WS heater 2, and while performing a defroster mode in which air not heated by the air conditioning heater 35 is blown toward the WS 1. In such manner, the total consumption of electric power is reducible, and the fogging of the WS 1 is cleared in a short time.

On the other hand, when it is determined in S41 that an occupant is not approaching the vehicle, when it is determined in S42 that the WS 1 is not fogged up, or after performing the process of S43, the air conditioning ECU 4 terminates the processing, and repeats the processes of S41 to S43 again at a predetermined control cycle.

The ninth embodiment described above has the following advantages.

(1) In the ninth embodiment, when the air conditioning ECU 4 detects that an occupant has approached the vehicle from outside the vehicle and detects that the WS 1 is fogged up based on an image captured by the in-vehicle camera 55, the air conditioning ECU 4 performs control to defog the WS 1. The control for clearing the fogging from the WS 1 may be a control for performing the defroster mode and heating the WS 1 with the WS heater 2.

According to the above, when the WS 1 is fogged up during stop of the vehicle and driving the WS heater 2 at an occupant boarding time, the air conditioning ECU 4 can drive the WS heater 2 when required, and can reduce the consumption of electric power by the WS heater 2. Further, fogging on the WS 1 can be cleared in a short time.

(2) Further, in the ninth embodiment, when (i) detecting that an occupant has approached the vehicle from outside the vehicle and (ii) detecting that the WS 1 is fogged up based on an image captured by the in-vehicle camera 55, the air conditioning ECU 4 performs control to clear the fogging of the WS 1. Control for clearing the fogging of the WS 1 may involve heating the WS 1 with the WS heater 2 and performing a defroster mode in which air not heated by the air conditioning heater 35 is blown toward the WS 1.

According to the above, when clearing the WS 1 already in the fogged state, the WS 1 is heated by the WS heater 2, thereby (i) not requiring the airflow in the defroster mode to be a warm airflow, and (ii) only requiring an airflow to prevent an increase in the relative humidity in the proximity of the WS 1. Therefore, the total consumption of electric power is reducible and fogging of the WS 1 can be cleared in a short time.

### Tenth Embodiment

The tenth embodiment will be described. The tenth embodiment is the same as the first embodiment except that it has a defogging feedforward control added thereto, and therefore only the differences from the first embodiment will be described.

The inventors of the present disclosure have discovered a problem in that fogging can occur on a WS 1 due to a sudden change in temperature or a sudden change in the inside air ratio, that is, for example, when the amount of solar radiation decreases due to entrance of the vehicle into a tunnel, when the amount of introduction of outside air is suddenly reduced due to exhaust gas control or the like. When the WS 1 is fogged, electric power will be consumed to clear the fogging.

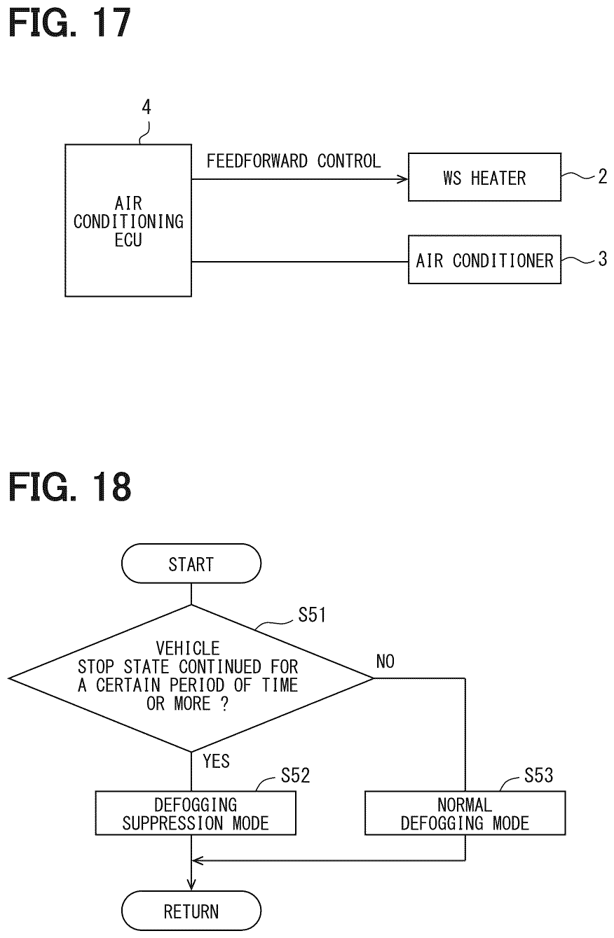

In contrast, as shown in FIG. 17, an air conditioning ECU 4 of the tenth embodiment is configured to perform feedforward control to increase the amount of electric current supplied to a WS heater 2 when fogging of the WS 1 is predicted based on the outside air temperature, the vehicle speed, the amount of solar radiation, and the inside air ratio.

The air conditioning ECU 4 of the tenth embodiment described above improves responsiveness through the feedforward control, and can prevent the WS 1 from fogging up even when there is a sudden change in the inside air ratio or a sudden change of the temperature. For example, when the inside air ratio suddenly increases due to exhaust gas control, or when the amount of solar radiation suddenly decreases upon entering a tunnel, the heat generation amount of the WS heater 2 can be increased to prevent fogging on the WS 1.

### Eleventh Embodiment

The eleventh embodiment will be described. The eleventh embodiment is the same as the first embodiment except that defogging control is added to the first embodiment, and therefore only the parts different from the first embodiment will be described.

In recent years, the number of people using their cars as a living space has increased, but when sleeping in a car, the windows may fog up. In such case, when a WS heater 2 is driven with a greater amount of electric power in a situation where ensuring visibility of the WS 1 is not required, such as when sleeping in a car, electric power will be excessively consumed.

Therefore, an air conditioning ECU 4 of the eleventh embodiment sets a defogging mode when the vehicle is stopped.

The defogging control when the vehicle is stopped performed by the air conditioning ECU 4 of the eleventh embodiment will be described with reference to the flowchart of FIG. 18.

In S51, the air conditioning ECU 4 determines whether the vehicle has been stopped for a predetermined period of time or more. Such a determination can be made, for example, from a state of a parking brake or a side brake. When it is determined that the vehicle has been stopped for a predetermined period of time or more, the process proceeds to S52.

In S52, the air conditioning ECU 4 performs a defogging suppression mode. In the defogging suppression mode, the heat generation amount of the WS heater 2 is controlled within a range where fogging of the WS 1 is allowed to a certain degree of not causing a problem.

On the other hand, when it is determined in S51 that the stopped state has not continued for a certain period of time or more, the process proceeds to S53. In S53, the air conditioning ECU 4 performs a normal defogging mode. In the normal defogging mode, the heat generation amount of the WS heater 2 is not suppressed, but is set to the heat generation amount in normal control.

After the processes of S52 and S53, the air conditioning ECU 4 repeats the process from S51 again.

The air conditioning ECU 4 of the eleventh embodiment described above can perform the defogging suppression mode in which the amount of electric current supplied to the WS heater 2 is suppressed when the vehicle has been stopped for a predetermined period of time or more.

According to the above, by setting the defogging suppression mode in the air conditioning ECU 4, the heat generation amount of the WS heater 2 can be controlled within a range where fogging is allowed to a certain degree of not causing a problem. Therefore, the consumption of electric power of the WS heater 2 is reducible.

### Twelfth Embodiment

The twelfth embodiment will be described. The twelfth embodiment is the same as the first embodiment, and the like, except that defogging control is added thereto, and therefore only the parts different from the first embodiment will be described.

The vehicle air conditioning system of the twelfth embodiment is mounted on a vehicle, such as an electric vehicle or a plug-in hybrid vehicle, whose vehicle driving battery can be charged. An air conditioning ECU 4 has, incorporated therein, control to energize a WS heater 2 when detecting an event that anticipates a driving of the vehicle (hereinafter referred to as a “vehicle driving flag”) (i) during charging of the vehicle driving battery or (ii) after a certain period of time from charging.

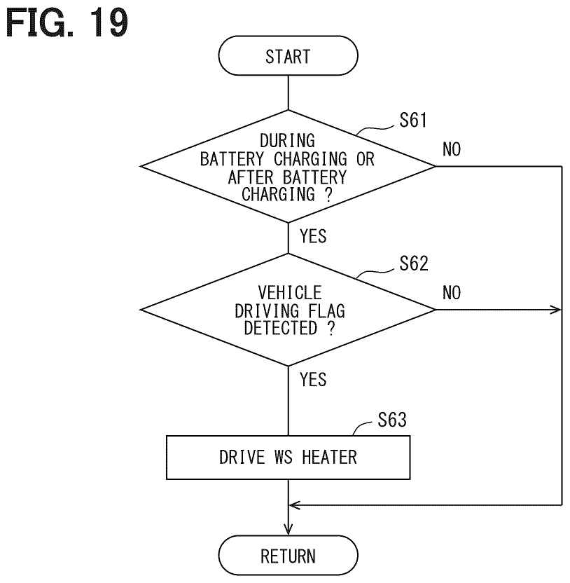

The defogging control performed by the air conditioning ECU 4 of the twelfth embodiment will be described with reference to the flowchart of FIG. 19.

In S61, the air conditioning ECU 4 determines whether the driving battery is being charged or whether a certain period of time has elapsed after charging. Whether the driving battery is being charged is determinable, for example, by checking whether a charging connector extending from a charging facility outside the vehicle is connected to a charging socket on the vehicle. Whether or not a certain period of time has elapsed after charging is determinable, for example, by determining whether or not a certain period of time has elapsed since the charging connector was removed from the charging socket on the vehicle. When it is determined that the driving battery is being charged or that a certain period of time has elapsed after charging, the process proceeds to S62.

In S62, the air conditioning ECU 4 determines whether a vehicle driving flag has been detected. Examples of the vehicle driving flag may be the driver's seat door opening, an occupant seated in the driver's seat, the parking brake or handbrake release, the start button or power switch pressed and the like. When the vehicle driving flag is detected, the process proceeds to S63.

In S63, the air conditioning ECU 4 drives the WS heater 2 when the WS 1 is fogged up. In such manner, a drive of the WS heater 2 starts before the occupant starts to drive the vehicle, and fogging of the WS 1 can be cleared. It should be noted that whether the WS 1 is fogged up is determinable by analyzing an image captured by the in-vehicle camera 55, for example.

On the other hand, when it is determined in S61 that the driving battery is not being charged or that a certain period of time has not elapsed after charging, when the vehicle driving flag is not detected in S62, or after the process of S63 has been performed, the air conditioning ECU 4 terminates the processing once. Then, the air conditioning ECU 4 repeats the above-described processes of S61 to S63 at a predetermined control cycle.

In the twelfth embodiment described above, the air conditioning ECU 4 drives the WS heater 2 when the WS 1 is fogged up in a situation that that the vehicle is expected to be driven (i) during charging the vehicle driving battery or after a certain period of time from charging. In such manner, the air conditioning ECU 4 drives the WS heater 2 when necessary while cooperating with the vehicle's charging device.

### Thirteenth Embodiment

The thirteenth embodiment will be described. The thirteenth embodiment differs from the first embodiment in that it has control processing by the air conditioning ECU 4 added thereto, but is otherwise similar to the first embodiment. Therefore, only the differences from the first embodiment will be described.

An air conditioning ECU 4 of the thirteenth embodiment performs control to drive both of an air conditioner 3 and a WS heater 2 in each of the deicing mode, the demisting mode, the defogging mode, and the human body temperature adjusting mode. Note that, in the description of the thirteenth embodiment, the deicing mode is a mode for deicing a WS 1. The demisting mode is a mode for clearing the fog on the WS 1. The defogging mode is a mode for preventing fogging of the WS 1. The human body temperature adjusting mode is a mode in which radiant heat from the WS heater 2 is used to warm the occupants seated in the front seats together with the conditioned air blown out from the air conditioner 3.

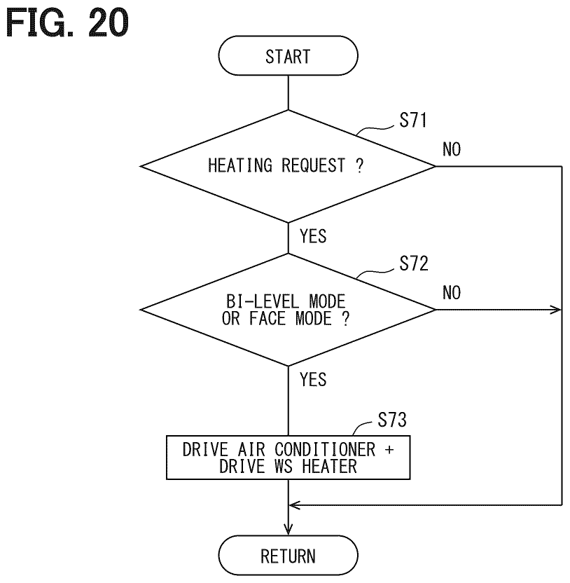

The control process in the human body temperature adjusting mode performed by the air conditioning ECU 4 of the thirteenth embodiment will be described with reference to the flowchart of FIG. 20. This process is incorporated into a part of an air conditioning control process and is repeatedly performed.

In S71, the air conditioning ECU 4 determines whether or not there is a heating request. Specifically, the heating request is determined based on whether the vehicle cabin temperature is lower than a set temperature. When there is a heating request, the process proceeds to S72.

In S72, the air conditioning ECU 4 determines whether a bi-level mode or a face mode has been selected by automatic control or by an operation by the occupant. When the bi-level mode or the face mode is selected, the process proceeds to S73.

In S73, the air conditioning ECU 4 performs control to drive the WS heater 2 together with the air conditioner 3. Specifically, the air conditioning ECU 4 drives the air conditioner 3 to blow out air heated by an air conditioning heater 35 from a designated outlet port. Specifically, when the bi-level mode is selected, warm air is blown out from a face air outlet port 18 and a foot air outlet port 19. When the face mode is selected, warm air is blown out from the face air outlet port 18. Further, the air conditioning ECU 4 energizes the WS heater 2 to generate heat. In such manner, an upper body of the occupant can be warmed by the radiant heat of the WS heater 2 together with the warm air blown out by the drive of the air conditioner 3.

On the other hand, when it is determined in S71 that there is no heating request, or when a mode other than the bi-level mode or the face mode is selected in S72, the process proceeds to the subsequent air conditioning control process (not shown).

The vehicle air conditioning system of the thirteenth embodiment described above provides the following advantageous effects.

(1) In the thirteenth embodiment, the air conditioning ECU 4 performs control to drive the WS heater 2 in each of the deicing mode, the demisting mode, the defogging mode, and the human body temperature adjusting mode.

According to the above, when the WS heater 2 is driven, the radiant heat of the WS heater 2 can warm the upper body of the occupant. Therefore, by using the WS heater 2 for adjusting human body temperature further to the deicing, demisting or defogging of the WS 1, the comfort of the air conditioning in the vehicle cabin is improvable and the total consumption of electric power is reducible.

(2) In the thirteenth embodiment, when the bi-level mode or the face mode is selected by automatic control or by the occupant's operation and the vehicle cabin temperature is lower than the set temperature, the air conditioning ECU 4 performs control to drive the air conditioner 3 and to drive the WS heater 2.

According to the above, when there is a heating request to warm the upper body of the occupant, the air conditioning ECU 4 drives the air conditioner 3 and also drives the WS heater 2. In such manner, the radiant heat of the WS heater 2 together with the warm air blown out from the air conditioner 3 can warm the upper body of the occupant. Therefore, the comfort of the air conditioning in the vehicle cabin is improvable and the total consumption of electric power is reducible.

### Fourteenth Embodiment

The fourteenth embodiment will be described. The fourteenth embodiment differs from the first embodiment in that it has control processing by the air conditioning ECU 4 added thereto, but is otherwise similar to the first embodiment. Therefore, only the differences from the first embodiment will be described.

The air conditioning ECU 4 of the fourteenth embodiment drives a WS heater 2 so that a WS 1 does not fog up, and also performs control to set a target blowout temperature TAO of the air conditioner 3 based at least on a heat generation amount of the WS heater 2, set temperature, vehicle cabin temperature, and outside air temperature.

According to the above, the air conditioning ECU 4 adds the heat generation amount of the WS heater 2 to the setting of the target blowout temperature TAO of the air conditioner 3. Therefore, the comfort of the air conditioning in the vehicle cabin is improvable and the total consumption of electric power is reducible.

The heat generation amount of the WS heater 2 may be determined by detecting a surface temperature of the WS 1 or, alternatively, by using the amount of energization to the WS heater 2. The heat generation amount of the WS heater 2 may also be predicted by detecting the temperature of the occupant or the temperature around the occupant with an infrared sensor.

Further, when the WS 1 is fogging up, it is preferable to give priority to heating the WS heater 2 for defogging purposes. After defogging the WS 1, the WS heater 2 is used for air conditioning the vehicle cabin. In such case, the air conditioning ECU 4 also adjusts the amount of electric power consumption of the air conditioner 3 and the amount of electric power consumption of the WS heater 2 so that the total consumption of electric power is minimized.

Heaters may also be provided on a side window 61 and on a rear window other than the WS 1. In such case, the air conditioning ECU 4 performs the air conditioning together with the heating by those heaters.

Note that, in case that the air conditioner 3 is configured to blow conditioned air into a vehicle rear side area of the vehicle cabin for heating, it is preferable that the air conditioning ECU 4 does not take into account the heat generation amount of the WS heater 2 when setting the target blowout temperature for the vehicle rear side area. Alternatively, it is preferable that the air conditioning ECU 4 corrects and controls the target blowout temperature for the vehicle rear side area so that the heat generation amount of the WS heater 2 is not added to the setting of the target blowout temperature for the vehicle rear side area. In such manner, the air conditioning for the comfort of the vehicle cabin is controlled to cover a wider area, while reducing the total consumption of electric power and preventing the WS 1 from fogging up.

### Other Embodiments

In the above-described embodiments, the air conditioning heater 35 of the air conditioner 3 is described as constituting a part of the water circuit 33. However, the configuration is not limited thereto. The air conditioning heater 35 may be provided in the air passage 27 of the air conditioning unit 8 to directly heat the air flowing through the air passage 27. Further, the air conditioning heater 35 is not limited to an electric heater, and may also be configured as a part of the condenser 30 of the refrigeration cycle 28.

The present disclosure is not limited to the embodiments described above, and can be appropriately changed. The above-described embodiments and a part thereof are not irrelevant to each other, and can be appropriately combined with each other unless the combination is obviously impossible. The constituent element(s) of each of the above-described embodiments is/are not necessarily essential unless it is specifically stated that the constituent element(s) is/are essential in the above-described embodiment, or unless the constituent element(s) is/are obviously essential in principle. Further, in each of the embodiments described above, when numerical values such as the number, numerical value, quantity, range, and the like of the constituent elements of the embodiment are referred to, except in the case where the numerical values are expressly indispensable in particular, the case where the numerical values are obviously limited to a specific number in principle, and the like, the present disclosure is not limited to the specific number. In each of the above-described embodiments, when the shapes, positional relationships, and the like of the constituent elements and the like are referred to, the shapes, positional relationships, and the like are not limited thereto unless otherwise specified or limited to specific shapes, positional relationships, and the like in principle.

The control unit and the method thereof described in the present disclosure may be implemented by a dedicated computer, which is configured by a processor and a memory programmed to execute one or more functions embodied by a computer program. Alternatively, the control unit and the method thereof described in the present disclosure may be implemented by a dedicated computer, which is configured by a processor and one or more dedicated hardware logic circuits. Alternatively, the control unit and the method thereof described in the present disclosure may be implemented by a combination of (i) a dedicated computer including a processor programmed to perform one or more functions by performing a computer program and a memory and (ii) a dedicated computer including a processor with one or more dedicated hardware logic circuits. The computer program may also be stored on a computer-readable, non-transitory, and tangible storage medium as instructions executable by a computer.

### Various Viewpoints of The Present Disclosure

The present disclosure described above can be understood from the following viewpoint, for example.

### [Viewpoint 1]

A vehicle air conditioning system includes:
a windshield heater (2) provided on a windshield (1) of a vehicle to heat the windshield;
an air conditioner (3) including (i) a blower unit (7) capable of adjusting a ratio of an amount of outside air introducing into a vehicle cabin and an amount of inside air circulating in the vehicle cabin, and (ii) an air conditioning unit (8) configured to heat the air supplied from the blower unit with an air conditioning heater (35) and to blow the air into the vehicle cabin;
an outside air temperature sensor (41) configured to detect an outside air temperature as a temperature outside the vehicle cabin;
an inside air temperature sensor (42) configured to detect an inside air temperature in the vehicle cabin; and
an air conditioning control device (4) configured to perform a control in which the windshield heater is driven to prevent the windshield from fogging up, the air conditioning heater is driven to control the inside air temperature of the vehicle cabin to a set temperature, and the blower unit is driven (i) to lower the ratio of the amount of the outside air introducing into the vehicle cabin and (ii) to increase the ratio of the amount of inside air circulating in the vehicle cabin in accordance with the outside air temperature.

### [Viewpoint 2]

In the vehicle air conditioning system of the Viewpoint 2, the blower unit includes: a blower (11); a blower unit case (9) having an outside air inlet port (12) for introducing outside air and an inside air inlet port (13) for introducing inside air in the vehicle cabin by a drive of the blower; and an inside/outside air switching door (10) configured to open and close the outside air inlet port and the inside air inlet port, and to adjust the amount of outside air introducing into the blower unit case from the outside air inlet port and the amount of inside air in the vehicle cabin introducing into the blower unit case from the inside air inlet port. In addition, the air conditioning control device is configured to set a position of the inside/outside air switching door at which the outside air and the inside air are simultaneously introduced into the blower unit case, to cause an abnormal noise generated by the outside air inlet port to be within a range in which an occupant cannot recognize as an abnormal noise.

### [Viewpoint 3]

In the vehicle air conditioning system of viewpoint 1, the blower unit includes: a blower (11); a blower unit case (9) having a first outside air inlet port (121) for introducing outside air, a second outside air inlet port (122) for introducing outside with an opening area smaller than the first outside air inlet port, and an inside air inlet port (13) for introducing inside air in the vehicle cabin by a drive of the blower; and an inside/outside air switching door (10) configured to open and close the first outside air inlet port, the second outside air inlet port, and the inside air inlet port. In addition, the second outside air inlet port has an aspect ratio that is within a range in which an abnormal noise generated when the inside/outside air switching door (10) opens the second outside air inlet port cannot be recognized as the abnormal noise by the occupant, and the air conditioning control device is configured to set a position of the inside/outside air switching door, at which the outside air and the inside air are simultaneously introduced into the blower unit case, and the inside air inlet port and the second outside air inlet port are opened, to cause an abnormal noise generated by the first outside air inlet port to be within a range in which an occupant cannot recognize as an abnormal noise.

### [Viewpoint 4]

In the vehicle air conditioning system of any one of viewpoints 1 to 3, the air conditioner is configured to perform a defroster mode in which air is blown toward the windshield. In this case, when the windshield in a fogged state is defogged, the air conditioning control device is configured to perform the defroster mode, and to heat the windshield by the windshield heater. When the windshield in a non-fogged state is defogged, the air conditioning control device is configured to stop an airflow or reduce an amount of airflow in the defroster mode, and to heat the windshield by the windshield heater.

### [Viewpoint 5]

In the vehicle air conditioning system of viewpoint 4, the air conditioning control device is configured to heat the windshield by the windshield heater and to perform the defroster mode in which air not heated by the air conditioning heater is blown toward the windshield, when the windshield in the fogged state is defogged.

### [Viewpoint 6]

In the vehicle air conditioning system of any one of viewpoints 1 to 5, the air conditioner is configured to perform a defroster mode in which air is blown toward the windshield, and the air conditioning control device is configured to perform
i) a control in which the defroster mode is set and the windshield is heated by the windshield heater, when the windshield in a fogged state is defogged in an automatic control,
ii) a control in which an airflow in the defroster mode is stopped or the amount of airflow is reduced, and the windshield is heated by the windshield heater, when the windshield in a non-fogged state is defogged in an automatic control, and
iii) a control in which the defroster mode or a foot/defroster mode is performed, and the windshield is heated by the windshield heater, when a defroster mode switch or a foot/defroster mode switch provided at a driver's seat is turned on by an occupant.

### [Viewpoint 7]

In the vehicle air conditioning system of any one of viewpoints 1 to 6, the air conditioning control device drives the blower unit to increase the amount of outside air introducing into the vehicle cabin, and reduce the amount of inside air circulating in the vehicle cabin, when a value obtained by subtracting a dew point temperature of a side window (61) of the vehicle from a temperature of the side window (61) becomes smaller than a predetermined threshold value.

### [Viewpoint 8]

In the vehicle air conditioning system of any one of viewpoints 1 to 7, the air conditioning control device drives the blower unit to increase the amount of outside air introducing into the vehicle cabin, to reduce the amount of inside air circulating in the vehicle cabin, and to perform a side defroster mode in which air is blown toward the side window, when a value obtained by subtracting a dew point temperature of a side window (61) of the vehicle from a temperature of the side window (61) becomes smaller than a predetermined threshold value.

### [Viewpoint 9]

The vehicle air conditioning system of viewpoint 7 or 8 further includes: a side window humidity sensor (51) provided on a cabin side of the side window; and a side window temperature sensor (52) provided on the cabin side of the side window. In addition, the air conditioning control device calculates the dew point temperature of the side window based on a relative humidity on the cabin side of the side window and the temperature of the side window.

### [Viewpoint 10]

The vehicle air conditioning system of viewpoint 7 or 8 further includes a side window temperature sensor (52) provided on a cabin side of the side window. In this case, the air conditioning control device is configured to estimate the dew point temperature of the side window based on (i) a relative humidity in the vehicle cabin estimated based on a number of occupants and (ii) the temperature of the side window.

### [Viewpoint 11]

The vehicle air conditioning system of viewpoint 7 or 8 further includes: a CO2 sensor (49) configured to detect a concentration of carbon dioxide in the vehicle cabin; and a side window temperature sensor (52) provided on a cabin side of the side window. In this case, the air conditioning control device is configured to estimate a dew point temperature of the side window based on (i) a relative humidity in the vehicle cabin estimated based on the concentration of carbon dioxide and (ii) the temperature of the side window.

### [Viewpoint 12]

In the vehicle air conditioning system of any one of viewpoints 1 to 11, the windshield heater is configured to have an electrical resistance per unit area of an outer periphery portion (54) of the windshield, which is lower than an electrical resistance per unit area of a central portion (53) of the windshield.

### [Viewpoint 13]

The vehicle air conditioning system of any one of viewpoints 1 to 12 further includes a windshield temperature sensor (46) configured to detect a temperature of the windshield. In this case, the air conditioning control device is configured to perform a control, in which the windshield heater heats the windshield when a relative humidity of a surface of the windshield calculated, based on (i) a humidity in the vehicle cabin estimated according to a number of occupants or a concentration of carbon dioxide in the vehicle cabin and (ii) the temperature of the windshield detected by the windshield temperature sensor, is higher than a predetermined humidity threshold value.

### [Viewpoint 14]

The vehicle air conditioning system of any one of viewpoints 1 to 12 further includes: a temperature and humidity sensor (47) provided in a rear side area than a center of a vehicle cabin in a front-rear direction to detect a temperature and relative humidity; and a windshield temperature sensor (46) provided to detect a temperature of the windshield. In this case, the air conditioning control device is configured to control the windshield heater to heat the windshield when a relative humidity of a surface of the windshield, calculated based on (i) the temperature and relative humidity detected by the temperature and humidity sensor and (ii) the temperature of the windshield detected by the windshield temperature sensor, is higher than a predetermined humidity threshold value.

### [Viewpoint 15]

In the vehicle air conditioning system of any one of viewpoints 1 to 14, the vehicle is installed with an in-vehicle camera (55) that captures images of outside of the vehicle through the windshield from inside the vehicle cabin, the in-vehicle camera is provided with a heating device (56) for heating its own lens, and the air conditioning control device is configured to control a drive operation of the heating device.

### [Viewpoint 16]

In the vehicle air conditioning system of any one of viewpoints 1 to 15, the vehicle is installed with an in-vehicle camera (55) that captures images of outside of the vehicle through the windshield from inside the vehicle cabin, and the air conditioning control device is configured to perform a defroster mode and to control the windshield heater to heat the windshield, when (i) detecting that an occupant has approached the vehicle from outside the vehicle and (ii) detecting that the windshield is fogged up from an image captured by the in-vehicle camera.

### [Viewpoint 17]

In the vehicle air conditioning system of viewpoint 16, the air conditioning control device is configured to heat the windshield by the windshield heater and to perform the defroster mode in which air that has not been heated by the air conditioning heater is blown toward the windshield, when (i) detecting that the occupant has approached the vehicle from outside the vehicle and (ii) detecting that the windshield is fogged up from the image captured by the in-vehicle camera.

### [Viewpoint 18]

In the vehicle air conditioning system of any one of viewpoints 1 to 17, the air conditioning control device is configured to perform a control in which an amount of electric current supplied to the windshield heater is increased, when fogging of the windshield is predicted based on the outside air temperature, a vehicle speed, an amount of solar radiation, and an inside air ratio to a sum of the amount of outside air introducing into the vehicle carbine and the amount of inside air circulating in the vehicle carbine.

### [Viewpoint 19]

In the vehicle air conditioning system of any one of viewpoints 1 to 18, the air conditioning control device is configured to perform a defogging suppression mode in which an amount of electric current supplied to the windshield heater is restricted, when the vehicle is stopped for a certain period of time or more.

### [Viewpoint 20]

In the vehicle air conditioning system of any one of viewpoints 1 to 19, the vehicle is an electric vehicle or a plug-in hybrid vehicle, and the air conditioning control device starts energization of the windshield heater when detecting an event that anticipates a drive of a vehicle (i) during charging of a vehicle driving battery or (ii) after a certain period of time from charging in case that the windshield is fogged up.

### [Viewpoint 21]

In the vehicle air conditioning system of any one of viewpoints 1 to 20, the air conditioning control device controls a drive operation of the windshield heater and the air conditioner, to cause a total consumption of electric power, which is a sum of (i) consumption of electric power of the windshield heater and (ii) consumption of electric power of the air conditioner, to approach a minimum value in accordance with the outside air temperature.

### [Viewpoint 22]

In the vehicle air conditioning system of any one of viewpoints 1 to 21, the air conditioning heater is an electric heater configured to generate heat when being energized, and to directly or indirectly heat air flowing through an air passage (27) of the air conditioner.

### [Viewpoint 23]

In the vehicle air conditioning system of any one of viewpoints 1 to 22, the air conditioning control device is configured to perform a control in which the blower unit is operated to lower a ratio of outside air introducing into the vehicle cabin and to increase a ratio of inside air circulating in the vehicle cabin in accordance with the outside air temperature, at least when the outside air temperature is equal to 0 degree in Celsius or lower.

### [Viewpoint 24]

In the vehicle air conditioning system of any one of viewpoints 1 to 23, the air conditioning control device is configured to perform a drive control of the windshield heater in each of a deicing mode in which the windshield is deiced, a demisting mode in which the windshield is demisted, a defogging mode in which the windshield is prevented from fogging, and a human body temperature adjusting mode in which an occupant is warmed using a radiant heat from the windshield heater and conditioned air blown from the air conditioner.

### [Viewpoint 25]

In the vehicle air conditioning system of any one of viewpoints 1 to 24, the air conditioning control device is configured to perform a drive control of the windshield heater together with an operation of the air conditioner, when a bi-level mode or a face mode is selected in an automatic control or by an operation of an occupant, in a condition in which the inside temperature of the vehicle carbine is lower than the set temperature.

### [Viewpoint 26]

In the vehicle air conditioning system of any one of viewpoints 1 to 25, the air conditioning control device is configured to drive the windshield heater to prevent the windshield from fogging up, and to perform a control in which a target temperature of conditioned air is set in the air conditioner based on at least a heat generation amount of the windshield heater, a set temperature, the inside air temperature and the outside air temperature.

### [Viewpoint 27]

An air conditioning control device for a vehicle is configured to control a windshield heater (2) provided on a windshield (1) of the vehicle and to control operation of an air conditioner. The vehicle is provided with: the windshield heater configured to heat the windshield; the air conditioner including a blower unit (7) capable of adjusting a ratio of an amount of outside air introducing into a vehicle cabin and an amount of inside air circulating in the vehicle cabin, and an air conditioning unit (8) configured to heat air supplied from the blower unit with an air conditioning heater (35) and to blow the air into the vehicle cabin; an outside air temperature sensor (41) configured to detect an outside air temperature as a temperature outside the vehicle cabin; and an inside air temperature sensor (42) configured to detect an inside air temperature in the vehicle cabin. In this case, the air conditioning control device is configured to perform a control in which the windshield heater is driven to prevent the windshield from fogging up, the air conditioning heater is driven to maintain the inside air temperature of the vehicle carbine at a set temperature, and the blower unit is driven to (i) lower a ratio of an amount of the outside air introducing into the vehicle cabin and (ii) increase a ratio of inside air circulating in the vehicle cabin in accordance with the outside air temperature.

### [Viewpoint 28]

A vehicle air conditioning system includes: a windshield heater (2) provided on a windshield (1) of a vehicle to heat the windshield; an air conditioner (3) including a blower unit (7) configured to drawn in outside air outside of the vehicle cabin and inside air inside of the vehicle cabin, and an air conditioning unit (8) configured to heat air supplied by the blower unit with an air conditioning heater (35) and to blow the air into the vehicle cabin; and an air conditioning control device (4) configured to perform a control in which the windshield heater is driven in each of a deicing mode in which the windshield is deiced, a demisting mode in which the windshield is demisted, a defogging mode in which the windshield is prevented from fogging, and a human body temperature adjusting mode in which an occupant is warmed using radiant heat from the windshield heater and conditioned air is blown out from the air conditioner.

### [Viewpoint 29]

In the vehicle air conditioning system according to viewpoint 28, the air conditioning control device is configured to perform a control in which the air conditioner and the windshield heater are driven when a bi-level mode or a face mode is selected in an automatic control or by operation of an occupant and when the inside air temperature of the vehicle cabin is lower than a set temperature.

### [Viewpoint 30]

In the vehicle air conditioning system according to viewpoint 28 or 29, the air conditioning control device is configured to perform a control in which (i) the windshield heater is driven to prevent the windshield from fogging up, and (ii) a target air temperature blown in the air conditioner is set based on at least a heat generation amount of the windshield heater, a set temperature, the inside air temperature of the vehicle cabin, and the outside air temperature.

What is claimed is:

1. A vehicle air conditioning system comprising:
a windshield heater provided on a windshield of a vehicle to heat the windshield;
an air conditioner including (i) a blower unit capable of adjusting a ratio of an amount of outside air introducing into a vehicle cabin and an amount of inside air circulating in the vehicle cabin, and (ii) an air conditioning unit configured to heat the air supplied from the blower unit with an air conditioning heater and to blow the air into the vehicle cabin;
an outside air temperature sensor configured to detect an outside air temperature as a temperature outside the vehicle cabin;
an inside air temperature sensor configured to detect an inside air temperature in the vehicle cabin; and
an air conditioning control device configured to perform a control in which the windshield heater is driven to prevent the windshield from fogging up, the air conditioning heater is driven to control the inside air temperature of the vehicle cabin to a set temperature, and the blower unit is driven (i) to lower the ratio of the amount of the outside air introducing into the vehicle cabin and (ii) to increase the ratio of the amount of inside air circulating in the vehicle cabin in accordance with the outside air temperature.

2. The vehicle air conditioning system of claim 1, wherein
the blower unit includes:
a blower;
a blower unit case having an outside air inlet port for introducing outside air and an inside air inlet port for introducing inside air in the vehicle cabin by a drive of the blower; and
an inside/outside air switching door configured to open and close the outside air inlet port and the inside air inlet port, and to adjust the amount of outside air introducing into the blower unit case from the outside air inlet port and the amount of inside air in the vehicle cabin introducing into the blower unit case from the inside air inlet port, and
the air conditioning control device is configured to set a position of the inside/outside air switching door at which the outside air and the inside air are simultaneously introduced into the blower unit case, to cause an abnormal noise generated by the outside air inlet port to be within a range in which an occupant cannot recognize as an abnormal noise.

3. The vehicle air conditioning system of claim 1, wherein
the blower unit includes:
a blower;
a blower unit case having a first outside air inlet port for introducing outside air, a second outside air inlet port for introducing outside with an opening area smaller than the first outside air inlet port, and an inside air inlet port for introducing inside air in the vehicle cabin by a drive of the blower; and
an inside/outside air switching door configured to open and close the first outside air inlet port, the second outside air inlet port, and the inside air inlet port,
the second outside air inlet port has an aspect ratio that is within a range in which an abnormal noise generated when the inside/outside air switching door opens the second outside air inlet port cannot be recognized as the abnormal noise by the occupant, and
the air conditioning control device is configured to set a position of the inside/outside air switching door, at which the outside air and the inside air are simultaneously introduced into the blower unit case, and the inside air inlet port and the second outside air inlet port are opened, to cause an abnormal noise generated by the first outside air inlet port to be within a range in which an occupant cannot recognize as an abnormal noise.

4. The vehicle air conditioning system of claim 1, wherein
the air conditioner is configured to perform a defroster mode in which air is blown toward the windshield,
when the windshield in a fogged state is defogged, the air conditioning control device is configured to perform the defroster mode, and to heat the windshield by the windshield heater, and
when the windshield in a non-fogged state is defogged, the air conditioning control device is configured to stop an airflow or reduce an amount of airflow in the defroster mode, and to heat the windshield by the windshield heater.

5. The vehicle air conditioning system of claim 4, wherein
the air conditioning control device is configured to heat the windshield by the windshield heater and to perform the defroster mode in which air not heated by the air conditioning heater is blown toward the windshield, when the windshield in the fogged state is defogged.

6. The vehicle air conditioning system of claim 1, wherein
the air conditioner is configured to perform a defroster mode in which air is blown toward the windshield, and
the air conditioning control device is configured to perform
i) a control in which the defroster mode is set and the windshield is heated by the windshield heater, when the windshield in a fogged state is defogged in an automatic control,
ii) a control in which an airflow in the defroster mode is stopped or the amount of airflow is reduced, and the windshield is heated by the windshield heater, when the windshield in a non-fogged state is defogged in an automatic control, and
iii) a control in which the defroster mode or a foot/defroster mode is performed, and the windshield is heated by the windshield heater, when a defroster mode switch or a foot/defroster mode switch provided at a driver's seat is turned on by an occupant.

7. The vehicle air conditioning system of claim 1, wherein
the air conditioning control device drives the blower unit to increase the amount of outside air introducing into the vehicle cabin, and reduce the amount of inside air circulating in the vehicle cabin, when a value obtained by subtracting a dew point temperature of a side window of the vehicle from a temperature of the side window becomes smaller than a predetermined threshold value.

8. The vehicle air conditioning system of claim 1, wherein
the air conditioning control device drives the blower unit to increase the amount of outside air introducing into the vehicle cabin, to reduce the amount of inside air circulating in the vehicle cabin, and to perform a side defroster mode in which air is blown toward the side window, when a value obtained by subtracting a dew point temperature of a side window of the vehicle from a temperature of the side window becomes smaller than a predetermined threshold value.

9. The vehicle air conditioning system of claim 7, further comprising:
a side window humidity sensor provided on a cabin side of the side window; and
a side window temperature sensor provided on the cabin side of the side window, wherein
the air conditioning control device calculates the dew point temperature of the side window based on a relative humidity on the cabin side of the side window and the temperature of the side window.

10. The vehicle air conditioning system of claim 7, further comprising:
a side window temperature sensor provided on a cabin side of the side window, wherein
the air conditioning control device is configured to estimate the dew point temperature of the side window based on (i) a relative humidity in the vehicle cabin estimated based on a number of occupants and (ii) the temperature of the side window.

11. The vehicle air conditioning system of claim 7, further comprising:
a CO2 sensor configured to detect a concentration of carbon dioxide in the vehicle cabin; and
a side window temperature sensor provided on a cabin side of the side window, wherein
the air conditioning control device is configured to estimate a dew point temperature of the side window based on (i) a relative humidity in the vehicle cabin estimated based on the concentration of carbon dioxide and (ii) the temperature of the side window.

12. The vehicle air conditioning system of claim 1, wherein
the windshield heater is configured to have an electrical resistance per unit area of an outer periphery portion of the windshield, which is lower than an electrical resistance per unit area of a central portion of the windshield.

13. The vehicle air conditioning system of claim 1, further comprising:
a windshield temperature sensor configured to detect a temperature of the windshield, wherein
the air conditioning control device is configured to perform a control, in which the windshield heater heats the windshield when a relative humidity of a surface of the windshield calculated, based on (i) a humidity in the vehicle cabin estimated according to a number of occupants or a concentration of carbon dioxide in the vehicle cabin and (ii) the temperature of the windshield detected by the windshield temperature sensor, is higher than a predetermined humidity threshold value.

14. The vehicle air conditioning system of claim 1, further comprising:
a temperature and humidity sensor provided in a rear side area than a center of a vehicle cabin in a front-rear direction to detect a temperature and relative humidity; and
a windshield temperature sensor provided to detect a temperature of the windshield, wherein
the air conditioning control device is configured to control the windshield heater to heat the windshield when a relative humidity of a surface of the windshield, calculated based on (i) the temperature and relative humidity detected by the temperature and humidity sensor and (ii) the temperature of the windshield detected by the windshield temperature sensor, is higher than a predetermined humidity threshold value.

15. The vehicle air conditioning system of claim 1, wherein
the vehicle is installed with an in-vehicle camera that captures images of outside of the vehicle through the windshield from inside the vehicle cabin,
the in-vehicle camera is provided with a heating device for heating its own lens, and
the air conditioning control device is configured to control a drive operation of the heating device.

16. The vehicle air conditioning system of claim 1, wherein
the vehicle is installed with an in-vehicle camera that captures images of outside of the vehicle through the windshield from inside the vehicle cabin, and
the air conditioning control device is configured to perform a defroster mode and to control the windshield heater to heat the windshield, when (i) detecting that an occupant has approached the vehicle from outside the vehicle and (ii) detecting that the windshield is fogged up from an image captured by the in-vehicle camera.

17. The vehicle air conditioning system of claim 16, wherein
the air conditioning control device is configured to heat the windshield by the windshield heater and to perform the defroster mode in which air that has not been heated by the air conditioning heater is blown toward the windshield, when (i) detecting that the occupant has approached the vehicle from outside the vehicle and (ii) detecting that the windshield is fogged up from the image captured by the in-vehicle camera.

18. The vehicle air conditioning system of claim 1, wherein
the air conditioning control device is configured to perform a control in which an amount of electric current supplied to the windshield heater is increased, when fogging of the windshield is predicted based on the outside air temperature, a vehicle speed, an amount of solar radiation, and an inside air ratio to a sum of the amount of outside air introducing into the vehicle carbine and the amount of inside air circulating in the vehicle carbine.

19. The vehicle air conditioning system of claim 1, wherein
the air conditioning control device is configured to perform a defogging suppression mode in which an amount of electric current supplied to the windshield heater is restricted, when the vehicle is stopped for a certain period of time or more.

20. The vehicle air conditioning system of claim 1, wherein
the vehicle is an electric vehicle or a plug-in hybrid vehicle, and
the air conditioning control device is configured to start energization of the windshield heater when detecting an event that anticipates a drive of a vehicle (i) during charging of a vehicle driving battery or (ii) after a certain period of time from charging.

21. The vehicle air conditioning system of claim 1, wherein
the air conditioning control device controls a drive operation of the windshield heater and the air conditioner, to cause a total consumption of electric power, which is a sum of (i) consumption of electric power of the windshield heater and (ii) consumption of electric power of the air conditioner, to approach a minimum value in accordance with the outside air temperature.

22. The vehicle air conditioning system of claim 1, wherein
the air conditioning heater is an electric heater configured to generate heat when being energized, and to directly or indirectly heat air flowing through an air passage of the air conditioner.

23. The vehicle air conditioning system of claim 1, wherein
the air conditioning control device is configured to perform a control in which the blower unit is operated to lower a ratio of outside air introducing into the vehicle cabin and to increase a ratio of inside air circulating in the vehicle cabin in accordance with the outside air temperature, at least when the outside air temperature is equal to 0 degree in Celsius or lower.

24. The vehicle air conditioning system of claim 1, wherein
the air conditioning control device is configured to perform a drive control of the windshield heater in each of a deicing mode in which the windshield is deiced, a demisting mode in which the windshield is demisted, a defogging mode in which the windshield is prevented from fogging, and a human body temperature adjusting mode in which an occupant is warmed using a radiant heat from the windshield heater and conditioned air blown from the air conditioner.

25. The vehicle air conditioning system of claim 1, wherein
the air conditioning control device is configured to perform a drive control of the windshield heater together with an operation of the air conditioner, when a bi-level mode or a face mode is selected in an automatic control or by an operation of an occupant, in a condition in which the inside temperature of the vehicle carbine is lower than the set temperature.

26. The vehicle air conditioning system of claim 1, wherein
the air conditioning control device is configured to drive the windshield heater to prevent the windshield from fogging up, and to perform a control in which a target temperature of conditioned air is set in the air conditioner based on at least a heat generation amount of the windshield heater, a set temperature, the inside air temperature and the outside air temperature.

27. An air conditioning control device for a vehicle, the air conditioning control device being configured to control a windshield heater provided on a windshield of the vehicle and to control operation of an air conditioner, the vehicle being provided with:
the windshield heater configured to heat the windshield;
the air conditioner including a blower unit capable of adjusting a ratio of an amount of outside air introducing into a vehicle cabin and an amount of inside air circulating in the vehicle cabin, and an air conditioning unit configured to heat air supplied from the blower unit with an air conditioning heater and to blow the air into the vehicle cabin;
an outside air temperature sensor configured to detect an outside air temperature as a temperature outside the vehicle cabin; and
an inside air temperature sensor configured to detect an inside air temperature in the vehicle cabin,
the air conditioning control device being configured to perform a control in which the windshield heater is driven to prevent the windshield from fogging up, the air conditioning heater is driven to maintain the inside air temperature of the vehicle carbine at a set temperature, and the blower unit is driven to (i) lower a ratio of an amount of the outside air introducing into the vehicle cabin and (ii) increase a ratio of inside air circulating in the vehicle cabin in accordance with the outside air temperature.

28. A vehicle air conditioning system comprising:
a windshield heater provided on a windshield of a vehicle to heat the windshield;
an air conditioner including
a blower unit configured to drawn in outside air outside of the vehicle cabin and inside air inside of the vehicle cabin, and
an air conditioning unit configured to heat air supplied by the blower unit with an air conditioning heater and to blow the air into the vehicle cabin; and
an air conditioning control device configured to perform a control in which the windshield heater is driven in each of a deicing mode in which the windshield is deiced, a demisting mode in which the windshield is demisted, a defogging mode in which the windshield is prevented from fogging, and a human body temperature adjusting mode in which an occupant is warmed using radiant heat from the windshield heater and conditioned air is blown out from the air conditioner.

29. The vehicle air conditioning system according to claim 28, wherein
the air conditioning control device is configured to perform a control in which the air conditioner and the windshield heater are driven when a bi-level mode or a face mode is selected in an automatic control or by operation of an occupant and when the inside air temperature of the vehicle cabin is lower than a set temperature.

30. The vehicle air conditioning system according to claim 28, wherein
the air conditioning control device is configured to perform a control in which (i) the windshield heater is driven to prevent the windshield from fogging up, and (ii) a target air temperature blown in the air conditioner is set based on at least a heat generation amount of the windshield heater, a set temperature, the inside air temperature of the vehicle cabin, and the outside air temperature.
